(19) United States
(12) Patent Application Publication
(10) Pub. No.: US 2010/0064070 A1
(43) Pub. Date: Mar. 11, 2010

(54) DATA TRANSFER UNIT FOR COMPUTER

(76) Inventors: Chihiro Yoshimura, Kokubunji (JP); Yoshiko Nagasaka, Kokubunji (JP); Naonobu Sukegawa, Inagi (JP); Koichi Takayama, Saitama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/546,386

(22) Filed: Aug. 24, 2009

(30) Foreign Application Priority Data
Sep. 1, 2008 (JP) 2008-223309

(51) Int. Cl. G06F 13/28

(52) U.S. Cl. 710/22

(57) ABSTRACT

In order to improve throughput by suppressing contention of hardware resources in a computer to which a data transfer unit is coupled, a control unit for transferring data between a first interface coupled to the computer and a second interface coupled to a memory transaction issuing unit for issuing, when one of the first interface and the second interface receives an access request to a memory of the computer, a memory transaction for the main memory to the first interface, the first interface includes a plurality of interfaces coupled in parallel to the computer, and the control unit further includes a memory transaction distribution unit for extracting an address of the main memory, which is contained in the memory transaction issued by the memory transaction issuing unit, and selecting an interface having address designation information set therein, which corresponds to the extracted address to transmit the memory transaction.

### CLAIM OF PRIORITY

The present application claims priority from Japanese patent application JP2008-223309 filed on Sep. 1, 2008, the content of which is hereby incorporated by reference into this application.

### BACKGROUND OF THE INVENTION

This invention relates to an apparatus, which is coupled to a computer, for transferring data to a main memory of the computer.

According to studies conducted by the inventors of this invention, in a data transfer unit which is involved in data inputting/outputting of a computer, such as a network interface adaptor, a storage interface adaptor, and a graphics adaptor, there is used direct memory access (DMA) transfer that transfers data to a main memory of the computer without using any processor. Load reduction on a processor and high speed data transfer are being attained by performing data transfer to the main memory without using any processor.

The data transfer unit is generally coupled to the computer via an interface defined by an industry standard such as PCI or PCI Express. Throughput of the interface is limited within a range defined by the standard. For example, in the PCI Express, six kinds of throughput, x1, x2, x4, x8, x16, and x32, are defined by the standard. When an interface having higher throughput is necessary, the standard needs to be revised. Thus, the performance (throughput) of the interface may become a bottleneck to reduce overall effective performance of the system. PCI Express Base Specification Revision 2.0, PCI-SIG, Dec. 20, 2006, and Mindshare Inc., Ravi Budruc, Don Anderson and Tom Shanley, PCI Express System Architecture (PC System Architecture Series), Addison-Wesley, Sep. 14, 2003 discuss the PCI Express.

For example, using inexpensively available computers (e.g., PCs) as nodes, and interconnecting a plurality of such nodes via a network to constitute a cluster enable realization of a high-performance computer as the entire cluster. In this case, depending on processing contents, overall effective performance of the cluster may be greatly reduced if network performance between the nodes is low. However, even when the network performance is improved, for the reason described above, if the performance of the interface for coupling the network interface adaptor to the computer is not matched with the network performance, the interface becomes a bottleneck to reduce the performance. In particular, in the case of a computer commodity such as an inexpensively available PC, no consideration is given to the problem with interface performance for constituting a cluster. Hence, the computer may not include any interface having data transfer performance necessary for constituting the cluster.

The example described above is of the case of the network interface adaptor. Further, similar problems arise in other data transfer units such as a storage interface adaptor and a graphics adaptor.

As means for attaining predetermined data transfer performance by using the interface of insufficient performance, a method that uses a plurality of interfaces is known. An example thereof is a technology described in JP 2000-330924 A. JP 2000-330924 A describes the technology of controlling, in a configuration in which a computer and a storage device are interconnected via a plurality of access paths, the computer to detect access paths coupled to the storage device, and distributing access to the storage device to the plurality of detected access paths.

As a technology using a plurality of interfaces, a technology of loading a plurality of graphics cards in a plurality of PCI Express slots, and rendering a single three-dimensional image is known (e.g., U.S. Pat. No. 7,289,125 and U.S. Pat. No. 7,075,541).

As a technology for coupling an interface such as PCI Express to a processor, there are used an internal network such as HyperTransport described in HyperTransport I/O Link Specification Revision 3.00, HyperTransport Technology Consortium, Apr. 21, 2006 or QuickPath Interconnect provided by Intel Corporation, to thereby secure throughput.

### SUMMARY OF THE INVENTION

As described above with regard to the background art, the data transfer unit for transferring data to the main memory of the computer may be coupled to the computer via the plurality of interfaces for the purpose of improving throughput of the data transfer. In this case, in order to realize the data transfer, the data transfer unit needs to distribute a plurality of memory transactions to the plurality of interfaces.

For example, a case where a data transfer unit includes two interfaces A and B to be coupled in parallel to a computer, and the computer includes two processors A and B and two main memories A and B is discussed. The processor A is coupled to the interface A via an I/O hub A, and the main memory A is coupled to the processor A. Similarly, the processor B is coupled to the interface B via an I/O hub B, and the main memory B is coupled to the processor B. The processors A and B are interconnected.

In the case of accessing the main memories A and B from the data transfer unit via the two interfaces A and B, when a memory transaction is issued from the interface A to the main memory A, and a memory transaction is issued from the interface B to the main memory B, the memory transactions are executed in parallel. As a result, improvement of throughput can be expected.

On the other hand, when a memory transaction is issued from the interface A to the main memory B, and a memory transaction is issued from the interface B to the main memory A, the processors A and B are interconnected, and transfer the two memory transactions. In this case, the interconnect between the processors A and B needs to have a transfer speed at least twice as high as that of a path between the processor A and the I/O hub A or between the processor B and the I/O hub B. When the transfer speed of the interconnect between the processors A and B is equal to that of another path, there is a problem that, even if memory transactions are distributed, a processing speed is equal to that in the case where a memory transaction is executed by one interface.

There is another problem that, when a failure occurs in any one of the paths between the interfaces A and B or between the interfaces A and B and the computer, unless distribution of a plurality of memory transactions is accordingly changed, transmission of the memory transactions is disabled.

There is a further problem that, when the data transfer unit issues memory write request transactions to the main memories A and B via the plurality of interfaces A and B, the data transfer unit cannot detect completion of writing in the main memories A and B. As a result, the data transfer unit cannot guarantee the completion of writing.

In order to solve the problems described above, it is an object of this invention to provide a data transfer unit that has the following features.

There is provided a data transfer unit that can improve throughput by suppressing contention of hardware resources on a path to a main memory or a main memory control unit among memory transactions transmitted to the main memory or the main memory control unit of a computer via a plurality of interfaces.

Further, there is provided a data transfer unit, which is coupled to a computer via a plurality of interfaces, and can maintain throughput of memory transactions for data transfer by guaranteeing completion of memory transactions and reducing overheads necessary for completion guaranteeing.

The foregoing object, other objects and new features of this invention will become apparent upon reading of the following detailed description in conjunction with accompanying drawings.

This invention provides a data transfer unit for transferring an input/output signal to be exchanged between a computer and an external device such as an I/O device. The data transfer unit includes control means for extracting, when the data transfer unit receives an access request to a main memory of the computer, an address of the main memory, which is contained in a memory transaction for the main memory, and selecting an appropriate interface among interfaces for transmitting signals or data to the computer according to the extracted address, to thereby transmit the memory transaction.

Thus, the data transfer unit of this invention includes a first interface for exchanging signals or data with the computer, and a second interface for exchanging signals or data with the external device. The control means is disposed between the first interface and the second interface. The first interface normally includes a plurality of interfaces.

A method of selecting an interface to be used for transferring a memory transaction can be realized by various configurations. For example, for each of the plurality of interfaces constituting the first interface, a transfer destination address or an address range (address information, hereinafter) of a memory transaction is preset. This correspondence is stored as address designation information, and collated with address information extracted from the received memory transaction to select an appropriate interface.

Alternatively, a plurality of interface selection rules may be prepared. A selection rule may be selected according to a type of a received memory transaction or a type of software operated in the computer, and an interface may accordingly be selected.

Effects obtained according to the representative aspects of this invention can be summarized as follows.

The first interface includes the plurality of interfaces, memory transactions transmitted to the main memory of the computer via the plurality of interfaces are transmitted, among the paths to the main memory, via a path in which contention of hardware resources is difficult to occur. Thus, effective performance of data transfer from the data transfer unit to the main memory can be improved.

Overheads caused by transmission of an additional memory transaction for guaranteeing completion of the memory transactions transmitted via the plurality of interfaces are reduced. Thus, effective performance of data transfer from the data transfer unit to the main memory can be improved.

The software operated on the computer can change a distribution method for memory transactions according to a configuration of the computer and characteristics of a user application that uses the data transfer unit. Thus, data transfer performance from the data transfer unit to the main memory can be improved. The change of the distribution method realizes a degenerate operation in which certain interfaces are cut off from the plurality of interfaces. As a result, even when abnormalities occur in certain interfaces, a data transfer unit that can continuously operate can be realized while data transfer performance is reduced.

As described above, this invention can improve data transfer performance from the data transfer unit to the main memory of the computer.

### BRIEF DESCRIPTION OF THE DRAWINGS

FIG. 1 illustrates a network realized by the network interface adaptor that is the data transfer unit according to a first embodiment of this invention.

FIG. 2 illustrates an example of a configuration of the node 102, according to the first embodiment of this invention.

FIG. 3 is a block diagram illustrating an example of a configuration of the network interface adaptor 201 serving as the data transfer unit according to the first embodiment of this invention.

FIG. 4 is a block diagram illustrating an example of the computer 203, according to the first embodiment of this invention.

FIG. 5 is an explanatory diagram illustrating an example of a configuration of the completion status storage unit 311, according to the first embodiment of this invention.

FIG. 6 illustrates an example of a configuration of the distribution information storage unit 308, according to the first embodiment of this invention.

FIG. 7 is an explanatory diagram illustrating a setting example of the distribution information storage unit 308 in the computer 203 of FIG. 4, according to the first embodiment of this invention.

FIG. 8 illustrates an example of a configuration of the distribution method setting unit 309, according to the first embodiment of this invention.

FIG. 9 is an explanatory diagram illustrating an example of the RDMA write request packet for requesting RDMA writing, according to the first embodiment of this invention.

FIG. 10 is an explanatory diagram illustrating an example of the RDMA read request packet for requesting RDMA reading, according to the first embodiment of this invention.

FIG. 11 is an explanatory diagram illustrating an example of the RDMA read response packet for returning data requested to be read in response to the RDMA read request, according to the first embodiment of this invention.

FIG. 12 illustrates an overall view of a propagation flow of the completion notification request, according to the first embodiment of this invention.

FIG. 13 is a flowchart illustrating processing performed when the controller 20 of the network interface adaptor 201 receives the RDMA write request packet 1400 from another node, according to the first embodiment of this invention.

FIG. 14 is a flowchart illustrating processing performed when the controller 20 of the network interface adaptor 201 receives the RDMA read request packet 1500 from another node, according to the first embodiment of this invention.

FIG. 15 is a flowchart illustrating processing performed when the controller 20 of the network interface adaptor 201 transmits the RDMA write request packet to another node, according to the first embodiment of this invention.

FIG. 16 is a flowchart illustrating processing performed when the controller 20 of the network interface adaptor 201 transmits the RDMA read request packet to another node, according to the first embodiment of this invention.

FIG. 17 is a flowchart illustrating an example of means for guaranteeing completion of processing of a memory transaction transmitted via the interface in the data transfer unit that performs data transfer with the main memory of the computer via the plurality of PCI Express interfaces, according to the first embodiment of this invention.

FIG. 18 illustrates an operation of the completion guaranteeing unit 312 for performing completion guaranteeing by using the completion status storage unit 311, according to the first embodiment of this invention.

FIG. 19 is a sequence diagram illustrating an operation of processing RDMA write request packets from a plurality of nodes in the data transfer unit of the first embodiment of this invention, according to the first embodiment of this invention.

FIG. 20 is an explanatory diagram illustrating an example of a stored content of the completion status storage unit when RDMA write request packets from a plurality of nodes coupled via the network are processed in the network interface adaptor coupled to the computer via four PCI Express interfaces, according to the first embodiment of this invention.

FIG. 21 is a block diagram illustrating another configuration of a computer to which the data transfer unit of the first embodiment of this invention is coupled.

FIG. 22 is an explanatory diagram illustrating an example of setting of the distribution information storage unit 308 in the case where this invention is applied to the computer 203A of FIG. 21.

FIG. 23 is a block diagram illustrating an example of a configuration of a processor in a computer to which the data transfer unit of the first embodiment of this invention is coupled.

### DETAILED DESCRIPTION OF THE PREFERRED EMBODIMENTS

Referring to the drawings, the preferred embodiments of this invention are described in detail. Throughout the drawings referred to for describing the embodiments, identical members are denoted by identical reference numerals in principle to avoid repeated description.

This invention can be applied to a data transfer unit for performing data transfer with a main memory or a main memory control unit of a computer via a plurality of interfaces. For example, this invention can be applied to a network interface adaptor, a storage interface adaptor, and a graphics adaptor. In an embodiment of this invention described below, this invention is applied to a network interface adaptor for performing remote direct memory access (RDMA) transfer. This application is suitable for describing a best embodiment to carry out this invention. However, the application of this invention is not limited to the network interface adaptor.

### First Embodiment

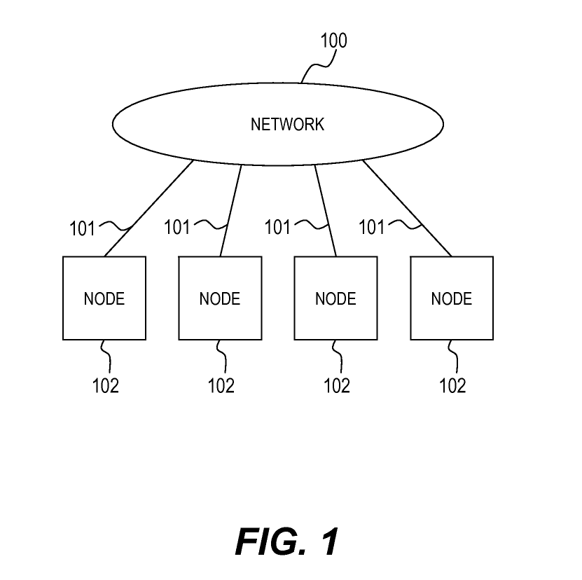

FIG. 1 illustrates a network realized by the network interface adaptor that is the data transfer unit according to the embodiment of this invention.

A network 100 is, for example, a network configured by InfiniBand. Nodes 102 that perform RDMA transfer with one another via the network 100 are coupled to the network via links 101. In the description below, when attention is paid on a certain node, the node is referred to as a local node, and another node coupled to the local node via the network 100 is referred to as a remote node.

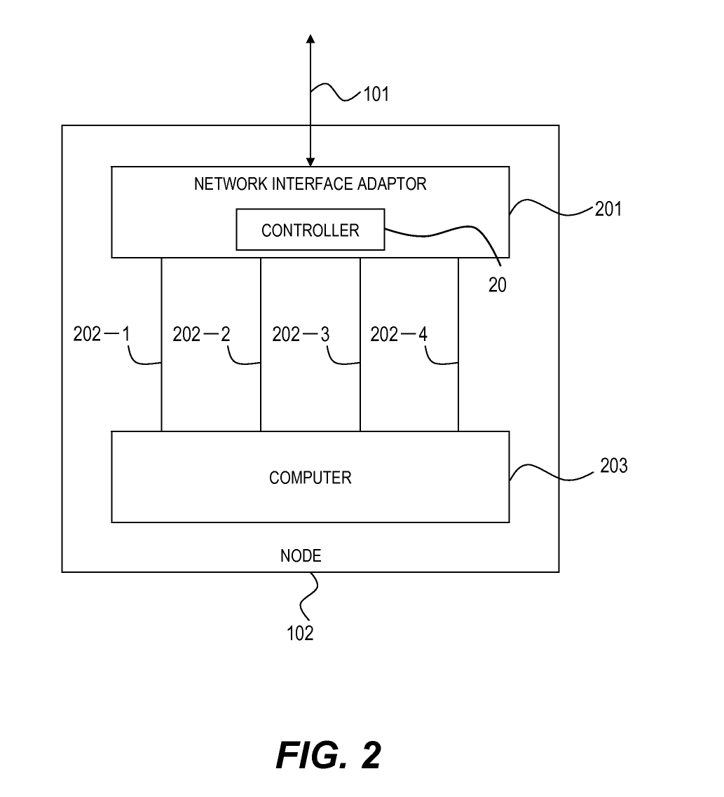

FIG. 2 illustrates an example of a configuration of the node 102. The node 102 includes a computer 203, and a network interface adaptor 201 for coupling the computer 203 to the network 100 via the link 101. The computer 203 and the network interface adaptor 201 are interconnected via at least two interfaces 202-1, 202-2, 202-3, and 202-4. FIG. 2 illustrates four interfaces. However, an arbitrary number of two or more interfaces can be disposed. The interfaces 202-1, 202-2, 202-3, and 202-4 are based on PCI Express in this embodiment. The network interface adaptor 201 mainly includes a controller 20 for processing signals.

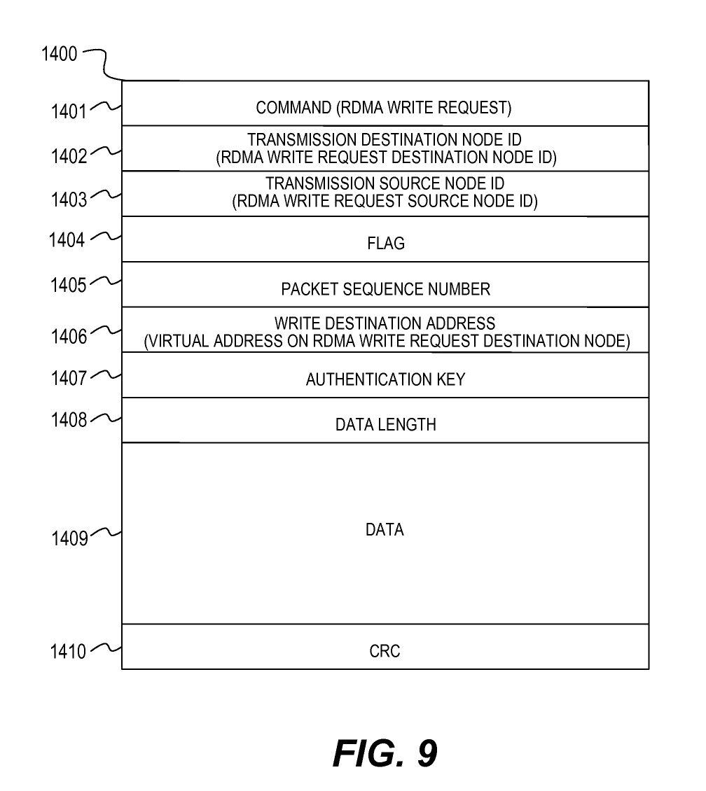

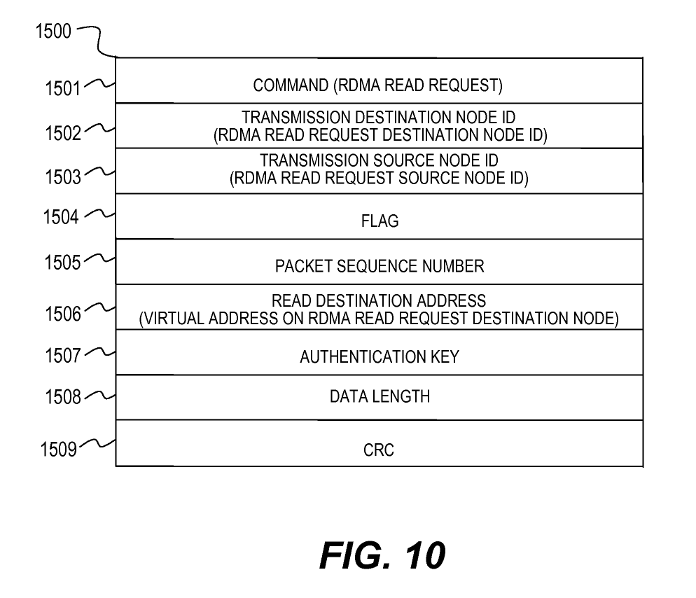

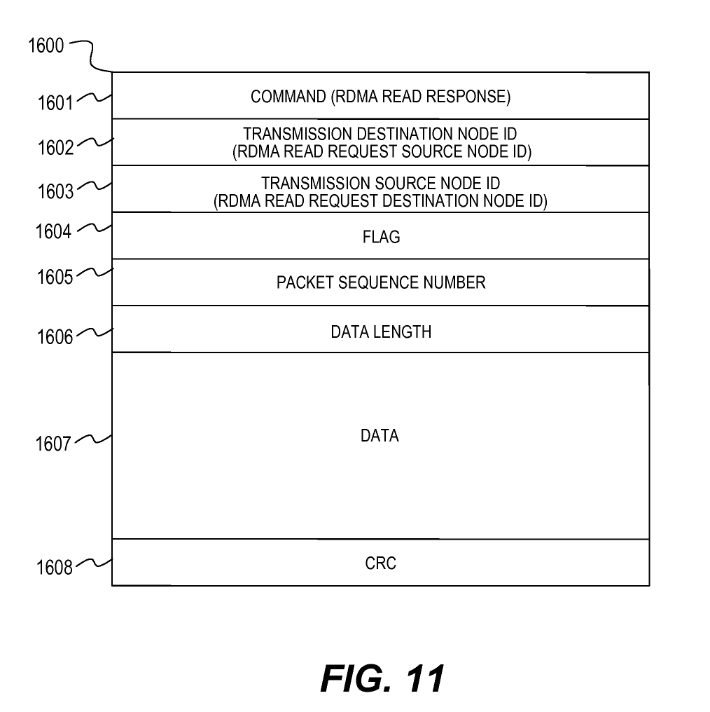

The network interface adaptor 201 serving as a data transfer unit generates, in response to a request from software operated in the computer 203, an RDMA transfer request packet for the remote node, and transmits the RDMA transfer request packet to the remote node via the network 100. When receiving an RDMA transfer request packet from the remote node to the local node, the network interface adaptor 201 generates and transmits a memory transaction and a packet necessary for executing the RDMA transfer request. There are three types of packets for requesting RDMA transfer, which are an RDMA write request packet 1400 illustrated in FIG. 9, an RDMA read request packet 1500 illustrated in FIG. 10, and an RDMA read response packet 1600 illustrated in FIG. 11. Each packet is described below in detail.

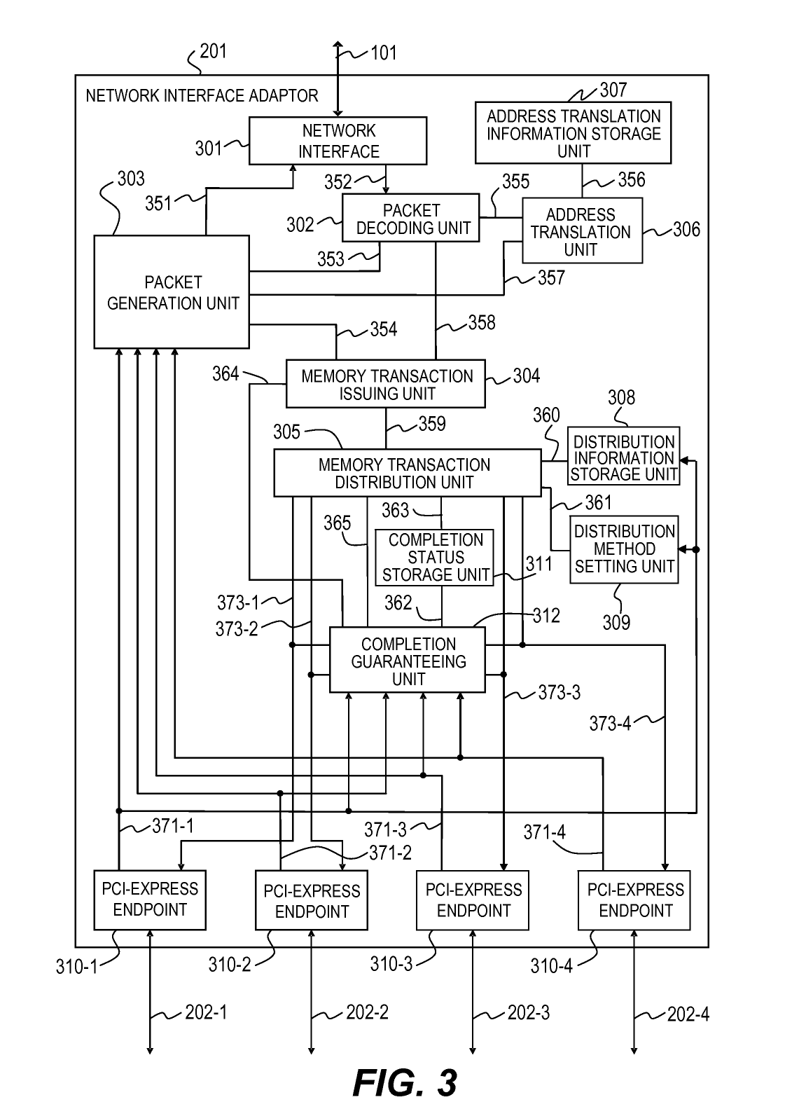

FIG. 3 is a block diagram illustrating an example of a configuration of the network interface adaptor 201 serving as the data transfer unit according to the embodiment of this invention. FIG. 3 illustrates functional elements of the controller 20 illustrated in FIG. 2 in detail. Each unit illustrated in FIG. 3 operates as a function of the controller 20. The controller 20 is accordingly configured by including a processor, a memory and a signal processing circuit.

In FIG. 3, the network interface adaptor 201 includes a network interface 301, a packet decoding unit 302, a packet generation unit 303, a memory transaction issuing unit 304, a memory transaction distribution unit 305, an address translation unit 306, an address translation information storage unit 307, a distribution information storage unit 308, a distribution method setting unit 309, at least two PCI Express endpoints 310-1, 310-2, 310-3, and 310-4, a completion status storage unit 311, and a completion guaranteeing unit 312.

The PCI Express endpoints 310-1, 310-2, 310-3, and 310-4 are responsible for processing of a physical layer, a data link layer, and a transaction layer defined by standard of PCI Express and necessary for coupling the network interface adaptor 201 to PCI Express interfaces 202-1, 202-2, 202-3, and 202-4.

As an example, the PCI Express endpoint 310-1 is described. The PCI Express endpoint 310-1 receives a PCI Express packet generated by the functional element of the network interface adaptor 201 via a control/data path 373-1, and transmits the packet to the PCI Express interface 202-1. The PCI Express endpoint 310-1 receives a PCI Express packet transmitted to the network interface adaptor 201 from the computer 203 via the PCI Express interface 202-1, and transmits the received packet to the functional element of the network interface adaptor 201 coupled via the control/data path 371-1. The PCI Express endpoint 310-1 performs processing for executing normal transfer of each packet, such as flow control during packet transmission/reception or error correction based on an error correcting code added to a packet with an I/O hub 400-1 of the computer 203 coupled via the PCI Express interface 202-1.

The PCI Express endpoint 310-1 has been described. The same applies to the PCI Express endpoints 310-2, 310-3, and 310-4. In other words, the PCI Express endpoint 310-2 transmits a packet transmitted to a control/data path 373-2 from the functional element of the network interface adaptor 201 to the PCI Express interface 202-2, and a packet transmitted to the PCI Express interface 202-2 from the computer 203 to a control/data path 371-2. The PCI Express endpoint 310-3 transmits a packet transmitted to a control/data path 373-3 from the functional element of the network interface adaptor 201 to the PCI Express interface 202-3, and a packet transmitted to the PCI Express interface 202-3 from the computer 203 to a control/data path 371-3. The PCI Express endpoint 310-4 transmits a packet transmitted to a control/data path 373-4 from the functional element of the network interface adaptor 201 to the PCI Express interface 202-4, and a packet transmitted to the PCI Express interface 202-4 from the computer 203 to a control/data path 371-4.

As described above, the PCI Express endpoints 310-1, 310-2, 310-3, and 310-4 transmit the packets transmitted from the functional elements of the network interface adaptor 201 to the PCI Express interfaces 202-1, 202-2, 202-3, and 202-4, and the packets transmitted to the PCI Express interfaces 202-1, 202-2, 202-3, and 202-4 from the I/O hubs 400-1 and 400-2 of the computer 203 to the functional elements of the network interface adaptor 201. The PCI Express endpoints 310-1, 310-2, 310-3, and 310-4 correspond to the PCI Express interfaces 202-1, 202-2, 202-3, and 202-4, respectively. Thus, transmission of a memory transaction to the PCI Express endpoint 310-1 from the functional element of the network interface adaptor 201 is synonymous with transmission of a memory transaction to the PCI Express interface 202-1 from the functional element. This relationship applies between the other PCI Express endpoints 310-2, 310-3, and 310-4 and the other PCI Express interfaces 202-2, 202-3, and 202-4.

The control/data path 371-1 is coupled to the packet generation unit 303, the completion guaranteeing unit 312, the distribution information storage unit 308, and the distribution method setting unit 309. Those four functional elements receive the packet from the PCI Express interface 202-1 via the PCI Express endpoint 310-1.

The control/data paths 371-2, 371-3, and 371-4 are coupled to the packet generation unit 303 and the completion guaranteeing unit 312. Those two functional elements receive the packets from the PCI Express interfaces 202-2, 202-3, and 202-4 via the PCI Express endpoints 310-2, 310-3, and 310-4.

The control/data paths 373-1, 373-2, 373-3, and 373-4 are coupled to the memory transaction distribution unit 305 and the completion guaranteeing unit 312. Those two functional elements transmit the PCI Express packets to the PCI Express interfaces 202-1, 202-2, 202-3, and 202-4 via the PCI Express endpoints 310-1, 310-2, 310-3, and 310-4.

The network interface 301 is coupled to the network 100 via the link 101. The network interface 301 transmits a packet input to the network interface 301 via a data path 351 to the network 100. A packet received from the network 100 is transferred to the packet decoding unit 302 via a data path 352.

The packet decoding unit 302 decodes a packet received via the network interface 301, and transmits control and information necessary for data transfer designated by the packet to another block.

The packet generation unit 303 generates a packet necessary for data transfer to transmit the packet via the network interface 301. The packet generation unit 303 transmits control and information necessary for obtaining data to generate a packet to another block.

The packet decoding unit 302 and the packet generation unit 303 decode and generate, in addition to the above-mentioned RDMA write request packet 1400, RDMA read request packet 1500, and RDMA read response packet 1600, an ACK packet for notifying transmission source nodes of those packets of arrival of the packets in a complete form, or an NACK packet for notifying the transmission sources of the packets of abnormalities when the arrived packets have losses.

The packet decoding unit 302 receives a received packet from the network interface 301 via the data path 352. The packet decoding unit 302 judges whether the packet has normally arrived without any loss by checking a CRC or a packet sequence number. As a result, if the packet is judged to be normal, the packet decoding unit 302 requests the packet generation unit 303 to transmit an ACK packet to the packet transmission source via a control path 353. If the packet is judged to be abnormal, the packet decoding unit 302 requests the packet generation unit 303 to transmit an NACK packet via the control path 353.

After checking of the packet, the packet decoding unit 302 judges processing requested by the packet, and requests the memory transaction issuing unit 304 to issue a memory transaction necessary for realizing the judged processing via a control/data path 358. In this case, an address or data necessary for issuing the memory transaction is transferred to the memory transaction issuing unit 304.

Packets that the packet decoding unit 302 can decode are, as described above, the RDMA write request packet 1400 illustrated in FIG. 9, the RDMA read request packet 1500 illustrated in FIG. 10, and the RDMA read response packet 1600 illustrated in FIG. 11. Each packet is described below in detail. Hereinafter, processing performed when the packet decoding unit 302 decodes each packet is described.

After reception of the RDMA write request packet 1400, the packet decoding unit 302 transmits, in order to translate a write destination address 1406 (virtual address) contained in the packet into a physical address, the write destination address 1406 to the address translation unit 306 via a data path 355, and receives the physical address obtained through translation performed by the address translation unit 306 via the data path 355. Then, the packet decoding unit 302 requests the memory transaction issuing unit 304 to issue a memory write request transaction for writing data 1409 to the physical address via the control/data path 358.

When the packet decoding unit 302 receives the RDMA read request packet 1500, similarly, a read destination address 1506 (virtual address) contained in the packet is translated into a physical address by the address translation unit 306. The packet decoding unit 302 requests the memory transaction issuing unit 304 to issue a memory read request transaction to the physical address. In this case, the packet decoding unit 302 requests the packet generation unit 303 to generate and transmit the RDMA read response packet 1600 containing data obtained by the memory read request transaction via the control path 353.

After reception of the RDMA read response packet 1600, the packet decoding unit 302 requests, via the control/data path 358, the memory transaction issuing unit 304 to issue a memory write request transaction for writing data 1607 contained in the RDMA read response packet 1600 in an area designated by an address of a main memory space, which is designated beforehand with respect to the network interface adaptor 201 by the computer 203. If the address of the main memory space has been designated as a virtual address, the packet decoding unit 302 requests the address translation unit 306 to translate the virtual address via the data path 355, and obtains a physical address obtained through translation from the address translation unit 306 via the data path 355 to make a request to the memory transaction issuing unit 304.

When the RDMA write request packet or the RDMA read response packet has an attribute added to request completion notification, the packet decoding unit 302 adds an attribute to request completion notification to the memory transaction issuing request transmitted to the memory transaction issuing unit 304 via the control/data path 358.

The address translation unit 306 translates, when an address of a local node contained in the RDMA request packet from a remote node is a virtual address, the address into a physical address based on translation information from a virtual address into a physical address, which is stored in the address translation information storage unit 307. When data necessary for generating a packet and transmitting the packet to the network is obtained from the main memory, the address translation unit 306 translates a virtual address into a physical address.

The address translation information storage unit 307 stores translation information necessary for translating a virtual address into a physical address by the address translation unit 306. A mounting form of the address translation information storage unit 307 may be a cache memory. Depending on a configuration of the computer 203 to which the network interface adaptor 201 is coupled, storage of all pieces of address translation information in the network interface adaptor 201 is difficult due to a necessary storage capacity. Thus, software such as a library, a device driver or an operating system of the computer 203 prepares address translation information in a predetermined area of the main memory, and the network interface adaptor 201 performs address translation by referring to the address translation information. However, it takes too long to obtain address translation information from the main memory for each address translation, thereby reducing performance. Hence, the cache memory is used to store the address translation information in the address translation information storage unit 307 of the network interface adaptor 201.

The memory transaction issuing unit 304 issues a memory read request transaction and a memory write request transaction necessary for data transfer to the main memory or the main memory control unit of the computer 203 in response to a request from the packet decoding unit 302 or the packet generation unit 303. The issued memory transactions are transferred to the memory transaction distribution unit via a data path 359.

Even if the packet decoding unit 302 or the packet generation unit 303 makes a memory transaction issuing request to the memory transaction issuing unit 304 only once, the memory transaction issuing unit 304 may divide a memory transaction to issue a plurality of memory transactions. Reasons are the following two.

The first reason is restrictions on the computer 203 on a side of receiving a memory transaction. For example, it is presumed that the packet decoding unit 302 receives an RDMA write request packet containing 4-kilobyte data, and requests the memory transaction issuing unit 304 to issue a memory write request transaction for writing the data in the main memory. If the maximum amount of data contained in one memory write request transaction is 256 bytes due to the restrictions on the computer 203, the memory transaction issuing unit 304 needs to divide the data into 16 pieces, and to issue 16 memory write request transactions for the 256-byte data.

The second reason is effective functioning of the memory transaction distribution unit 305 described below. As described below, the memory transaction distribution unit 305 disperses loads imposed on the interfaces to improve throughput by dispersing and transmitting a plurality of memory transactions to the plurality of PCI Express interfaces. Hence, the memory transaction distribution unit 305 cannot effectively function when the number of memory transactions is only one. Thus, in order to write an enormous amount of data, as in the case of the above-mentioned example, the data is divided into small pieces of data and a plurality of memory write request transactions are issued in parallel.

When the memory transaction issuing request from the packet decoding unit 302 has an attribute added to request completion notification, the memory transaction issuing unit 304 transmits a memory transaction to the memory transaction distribution unit 305 via the data path 359, and subsequently transmits information for requesting completion notification to the memory transaction distribution unit 305.

The memory transaction distribution unit 305 selects any one of the plurality of PCI Express interfaces 202-1, 202-2, 202-3, and 202-4, and transmits one of memory transactions issued from the memory transaction issuing unit 304 to the selected interface. As a method for selecting one of the plurality of PCI Express interfaces 202-1, 202-2, 202-3, and 202-4, round-robin, weighted round-robin, or interleaving by a target address of a memory transaction may be applied. However, as described above in “BACKGROUND OF THE INVENTION”, depending on a configuration of the computer 203 and a transmission pattern of a memory transaction, those methods may only reduce data transfer performance from the network interface adaptor 201 to the main memory of the computer 203.

According to this invention, the distribution information storage unit 308 is newly disposed in the network interface adaptor 201, and the memory transaction distribution unit 305 selects a PCI Express interface to be used for transmitting a memory transaction by using correspondence between the main memory address and the PCI Express interface, the correspondence being stored in the distribution information storage unit 308.

The distribution information storage unit 308 stores at least one entry, with a set of a range of a main memory address controlled by the plurality of main memories or main memory control units of the computer 203 and information indicating an interface capable of transmitting a memory transaction on a relatively short path to the main memory or the main memory control unit as one entry. The memory transaction distribution unit 305 can refer to data of the distribution information storage unit 308 via a data path 360.

After reception of the memory transaction issued from the memory transaction issuing unit 304 via the data path 359, the memory transaction distribution unit 305 extracts an entry of a main memory address range to which a target address of the memory transaction belongs by referring to the distribution information storage unit 308. If the entry is present, the memory transaction is transmitted to a PCI Express interface designated by the entry. If no entry is present, the memory transaction is transmitted to an interface set as a default transmission destination.

Contents of the distribution information storage unit 308 are set by software such as the library, the device driver or the operating system operated on the computer 203 at the time of initialilzation of the network interface adaptor 201. The distribution information storage unit 308 is a memory mapped register allocated to the main memory address space of the computer, and coupled to the PCI Express endpoint 310-1 via the data path 371-1. The software can accordingly set contents of the distribution information storage unit 308 by issuing a memory write request transaction targeting an address of the distribution information storage unit 308 to the PCI Express interface 202-1. An example of a more detailed configuration of the distribution information storage unit 308 and an example of information recorded on the distribution information storage unit 308 are described below.

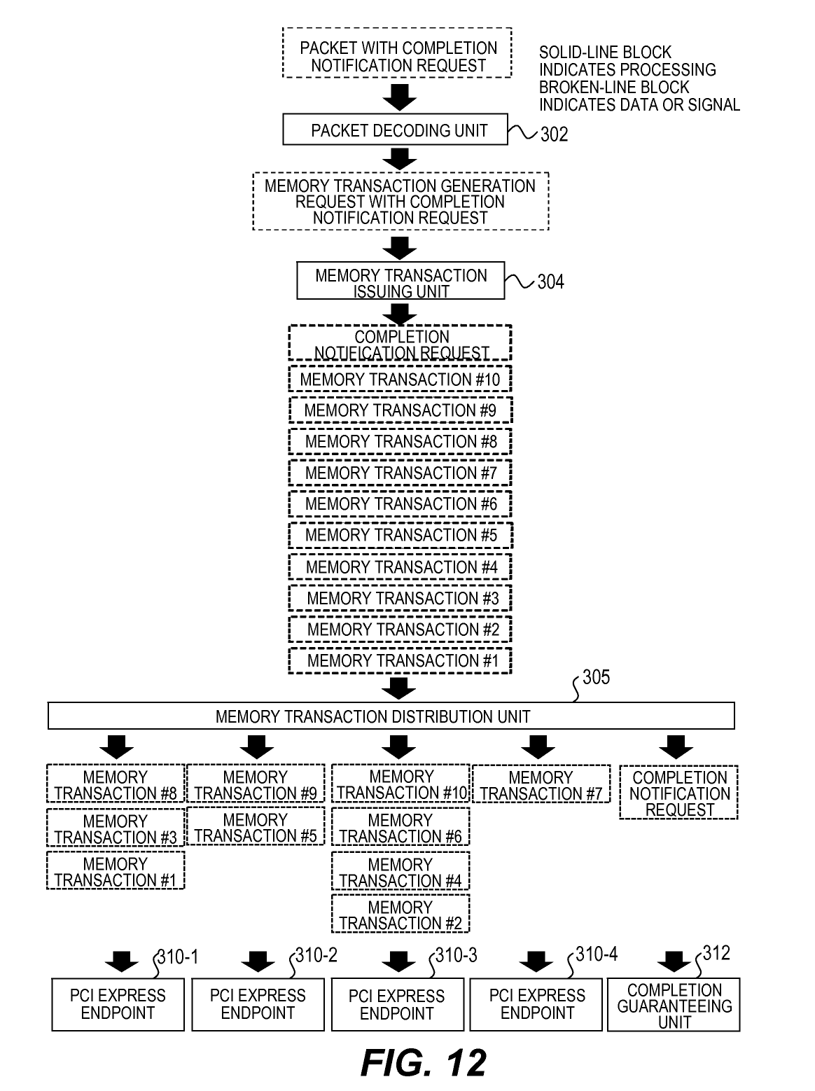

After reception of a completion notification request from the memory transaction issuing unit 304 via the data path 359, the memory transaction distribution unit 305 completes distribution of the memory transactions received thus far, and then requests, via the control path 365, the completion guaranteeing unit 312 to perform processing of guaranteeing completion of the transmitted memory transactions and notifying of the completion. FIG. 12 illustrates an overall view of a propagation flow of the completion notification request. FIG. 12 is an explanatory diagram illustrating a status from reception of a packet of the completion notification request at the packet decoding unit 302 to distribution of the memory transactions at the memory transaction distribution unit 305.

The configuration described above enables transfer of a memory transaction to a destination within a short period of time, and reduction of congestion of interconnects in the computer 203.

There can be used a plurality of methods for selecting one of the plurality of PCI Express interfaces 202-1, 202-2, 202-3 and 202-4. For distribution of memory transactions using the distribution information storage unit 308 of this invention, as described in this embodiment, high data transfer performance can be realized by using a distribution method such as round-robin, weighted round-robin or interleaving by an address depending on the configuration of the computer 203. However, as described above, contents of the distribution information storage unit 308 need to be set beforehand. Thus, unless the library, the device driver or the operating system is compatible, distribution of memory transactions based on the distribution information storage unit 308 is impossible. While data transfer performance may drop, in order to normally operate the network interface adaptor 201 even in such a situation, the memory transaction distribution unit 305 needs to support the plurality of distribution methods as described above, and to set a distribution method actually used for distribution among the plurality of distribution methods by the software operated on the computer 203. When coupling to the computer 203 via a single PCI Express interface even sacrificing software debugging or performance of the network interface adaptor 201, a memory transaction needs to be transmitted to one of the plurality of PCI Express interfaces 202-1, 202-2, 202-3, and 202-4, which is designated by the software operated in the computer 203 in a fixed manner. When any one of the PCI Express endpoints 310-1, 310-2, 310-3, and 310-4 becomes unusable due to a failure, when any one of the PCI Express interfaces 202-1, 202-2, 202-3, and 202-4 coupled to the respective endpoints becomes unusable, or when a failure occurs in any one of the I/O hubs 400-1 and 400-2 of the computer, in order to continue a degenerate operation, distribution of memory transactions to the unusable PCI Express endpoint or the unusable PCI Express interface needs to be inhibited. In order to satisfy those needs, according to this invention, the network interface adaptor 201 includes the distribution method setting unit 309 for designating a distribution method used by the memory transaction distribution unit 305 described above from the software of the computer 203.

The distribution method setting unit 309 is coupled to the PCI Express endpoint 310-1 via the data path 371-1 to function as a memory mapped register mapped in the main memory address space of the computer 203. The software operated in the computer 203 can set contents of the distribution method setting unit 309 by issuing a memory write request transaction with respect to the address, to the PCI Express interface 202-1.

After transmission of a memory write request transaction, at least one memory write request transaction whose processing may be yet to be completed is present in the interface selected as a transmission destination. The memory transaction distribution unit 305 records information indicating presence of uncompleted memory write request transactions on the PCI Express interface on the completion status storage unit 311 via a data path 363.

The completion status storage unit 311 of this invention stores completion of all the issued memory write request transactions or a possibility of uncompleted memory write request transactions remaining in the PCI Express interfaces 202-1, 202-2, 202-3, and 202-4 coupled to the plurality of PCI Express endpoints 310-1, 310-2, 310-3, and 310-4 of the network interface adaptor 201. An example of a more detailed configuration of the completion status storage unit 311 and an example of a stored content of the completion status storage unit 311 in the case where the network interface adaptor 201 processes an RDMA transfer request are described below.

The completion guaranteeing unit 312 guarantees, in response to a request from the software operated in the computer 203 or from the remote node, processing completion of the memory transactions transmitted from the network interface adaptor 201 to the main memory or the main memory control unit of the computer 203 via the PCI Express interfaces 202-1, 202-2, 202-3, and 202-4, and notifies the software operated in the computer 203 or the remote node of the processing completion. In this case, in order to minimize the transmission amount of additional transactions necessary for completion guaranteeing, according to this invention, the network interface adaptor 201 includes the completion status storage unit 311.

The completion guaranteeing unit 312 performs, when receiving a completion notification request from the memory transaction distribution unit 305 via a control path 365, processing necessary for completion guaranteeing, for an interface having a memory write request transaction uncompleted in the completion status storage unit 311. At a stage at which completion of the memory write request transaction can be guaranteed in the interface, information indicating that processing of the memory write request transaction transmitted to the interface has been completed is recorded on the completion status storage unit 311. At a stage at which completion of memory write request transactions can be guaranteed in all the interfaces, in other words, at a stage at which the interfaces whose status is indicated as uncompleted in the completion status storage unit 311 described above and which has performed processing necessary for completion guaranteeing have all been indicated as completed, the computer 203 or the remote node is notified of completion of the memory write request transactions. The completion guaranteeing unit 312 requests the memory transaction issuing unit 304 to issue a memory transaction to the computer 203, which is necessary for completion guaranteeing of the memory write request transactions via a data path 364.

The network interface adaptor 201 of this embodiment is coupled to the computer 203 via the four PCI Express interfaces 202-1, 202-2, 202-3, and 202-4. In order to couple the network interface adaptor 201 to the computer 203 via a larger number of PCI Express interfaces, the number of PCI Express interfaces increases, and the number of PCI Express endpoints of the network interface adaptor 201 associatively increases. The increased PCI Express endpoints are coupled to the memory transaction distribution unit 305, the packet generation unit 303, and the completion guaranteeing unit 312. The memory transaction distribution unit 305 handles all the coupled PCI Express endpoints (and PCI Express interfaces coupled to the PCI Express endpoints) as memory transaction distribution destinations.

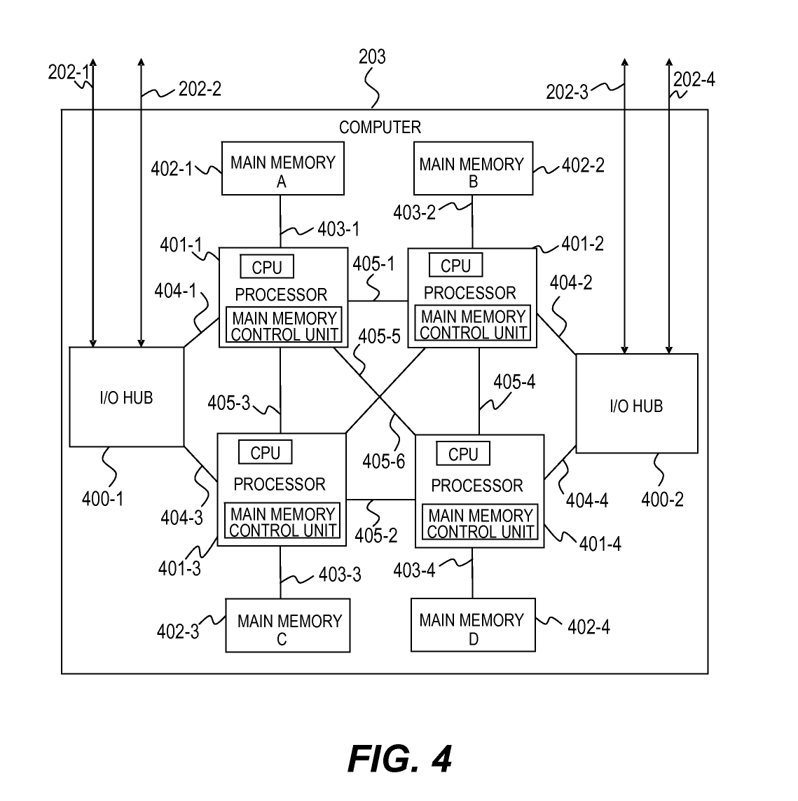

FIG. 4 is a block diagram illustrating an example of the computer 203 which is coupled to the network interface adaptor 201, and constitutes the node 102.

The computer 203 illustrated in FIG. 4 includes the I/O hubs 400-1 and 400-2 for coupling the network interface adaptor 201 via the plurality of interfaces. The I/O hub 400-1 is coupled to processors 401-1 and 401-3 via interconnects 404-1 and 404-3. The I/O hub 400-2 is coupled to processors 401-2 and 401-4 via interconnects 404-2 and 404-4. interconnects 405-1, 405-2, 405-3, 405-4, 405-5, and 405-6 couple the processors 401-1, 401-2, 401-3, and 401-4 with one another.

The I/O hubs 400-1 and 400-2 provide the plurality of PCI Express interfaces 202-1, 202-2, 202-3, and 202-4 for coupling the network interface adaptor 201. Those interfaces are coupled to the network interface adaptor 201. In other words, the I/O hub 400-1 is coupled to the PCI Express endpoints 310-1 and 310-2 of the network interface adaptor 201 via the PCI Express interfaces 202-1 and 202-2. Similarly, the I/O hub 400-2 is coupled to the PCI Express endpoints 310-3 and 310-4 of the network interface adaptor 201 via the PCI Express interfaces 202-3 and 202-4.

The processors 401-1, 401-2, 401-3, and 401-4 include main memory control units, and are coupled to main memories 402-1, 402-2, 402-3, and 402-4 via memory buses 403-1, 403-2, 403-3, and 403-4, respectively. The interconnects 404-1, 404-2, 404-3, 404-4, 405-1, 405-2, 405-3, 405-4, 405-5, and 405-6 are interconnects such as HyperTransport (HyperTransport I/O Link Specification Revision 3.00, HyperTransport Technology Consortium, Apr. 21, 2006) or the QuickPath Interconnect.

The computer 203 includes a single main memory space, and the main memories 402-1, 402-2, 402-3, and 402-4 are parts of the main memory space.

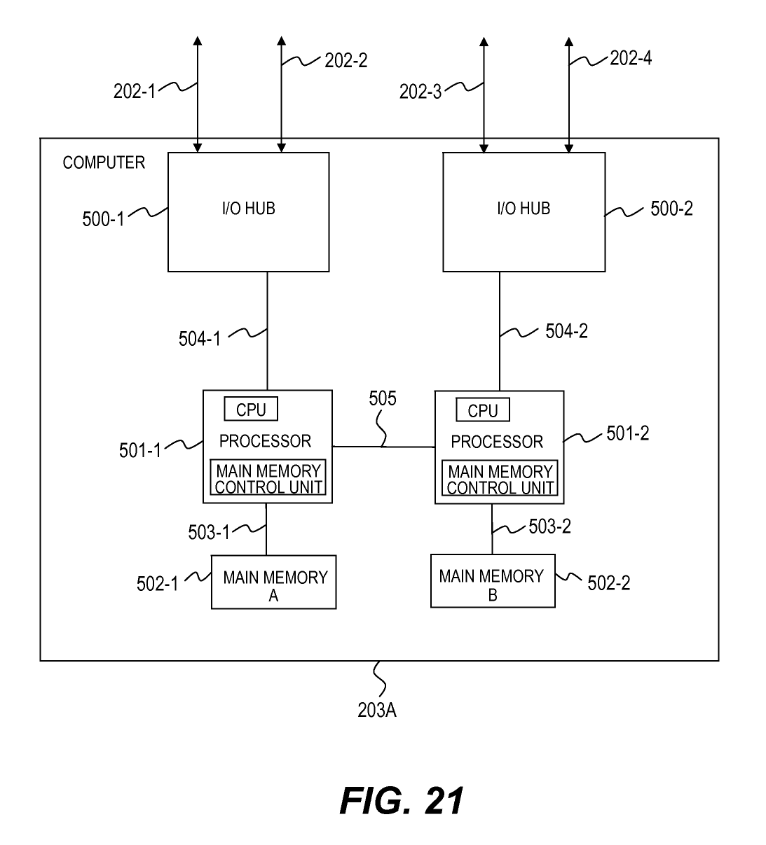

In the case of the computer 203 illustrated in FIG. 4, there can be a plurality of the interconnects 405-1, 405-2, 405-5, and 405-6 as paths for transmitting, to the processors 401-2 and 401-4 close to the I/O hub 400-2, memory transactions that have arrived via the I/O hub 400-1 or conversely paths for transmitting, to the processors 401-1 and 401-3 close to the I/O hub 400-1, memory transactions that have arrived via the I/O hub 400-2. Thus, unlike an interconnect 505 illustrated in FIG. 21, a plurality of transactions can be simultaneously transmitted from the I/O hub 400-1 to the processors 401-2 and 401-4 or from the I/O hub 400-2 to the processors 401-1 and 401-3 through different paths, and reduction in data transfer performance caused by contention of a plurality of memory transactions on the interconnects is small.

However, there remains a problem of a variation on latency from one path to another for transferring transactions. As an example in which latency is largest, in particular, memory transactions may reach the processor 401-4 from the I/O hub 400-1 via the interconnect 404-1, the processor 401-1, the interconnect 405-1, the processor 401-2, and the interconnect 405-4. At the interconnects 405-1, 405-2, 405-3, 405-4, 405-5, and 405-6 between the processors, not only memory transactions are transferred with the I/O hub but also data is transferred between the processors. Hence, in order to prevent contention, the interconnects between the processors are preferably prevented from being used for transferring memory transactions from the I/O hub. In particular, in a data transfer unit such as the network interface adaptor 201 for performing DMA transfer, the DMA transfer is carried out so that the processor can execute other processing while data is transferred to the main memory without any loads on the processor.

Thus, congestion of the interconnects between the processors with memory transactions, which is caused by the data transfer unit, is desirably prevented from reducing performance of one of processings performed by the processors, which involve inter-processor communication. An example of processing involving inter-processor communication is a case where a plurality of processors cooperatively carry out calculation, and executes communication using the interconnects between the processors for necessary data transfer or barrier synchronization. During this processing, when a result of the calculation is transmitted to another node via the network or stored in the storage device, data needs to be transferred from the main memory so as not to block the calculation performed by the processors by using DMA transfer. In view of this status, even the computer illustrated in FIG. 4 needs means disclosed by this invention.

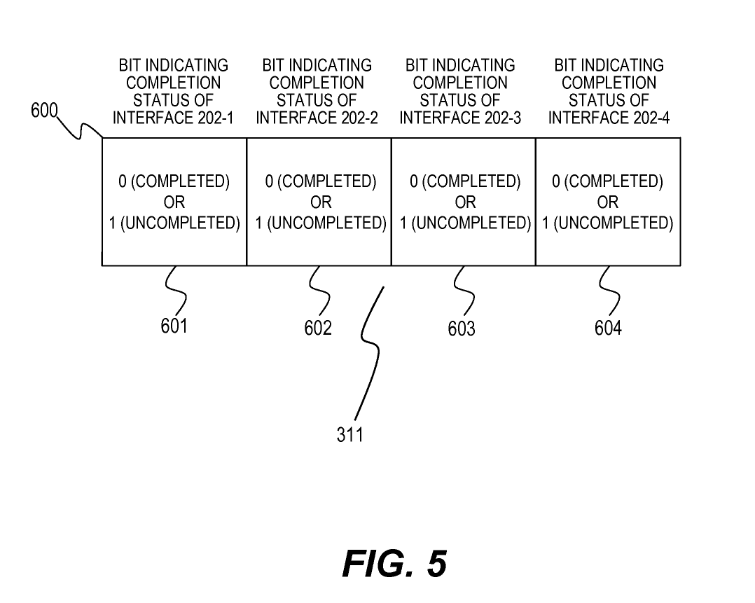

FIG. 5 is an explanatory diagram illustrating an example of a configuration of the completion status storage unit 311. The completion status storage unit 311 may be configured as a register that has the number of bits equal to that of PCI Express interfaces to which the network interface adaptor 201 is coupled. In this embodiment, the network interface adaptor 201 is coupled to the four PCI Express interfaces 202-1, 202-2, 202-3, and 202-4 via the PCI Express endpoints 310-1, 310-2, 310-3, and 310-4, and hence the completion status storage unit 311 is a 4-bit register 600.

Bits 601, 602, 603, and 604 of the register 600 respectively correspond to the PCI Express interfaces 202-1, 202-2, 202-3, and 202-4. The bits 601, 602, 603 and 604 hold a binary of 0 or 1. The value 0 indicates that processing for a memory write request transaction having been transmitted to the interface corresponding to the bit has been completed. The completion of processing means that in the case of the memory write request transaction, data to be written by the memory write request transaction can be observed from the processor of the computer. The value 1 indicates a possibility that a memory write request transaction for which the processing is yet to be completed may be included in memory write request transactions having been transmitted to the interface corresponding to the bit.

As a mounting example, the completion status storage unit 311 can be mounted by the number of flip-flops equal to the number of bits. Flip-flops equal in number to the PCI Express interfaces to which the network interface adaptor 201 is coupled only need to be prepared in the network interface adaptor 201, and hence no great load is imposed in terms of a hardware physical amount.

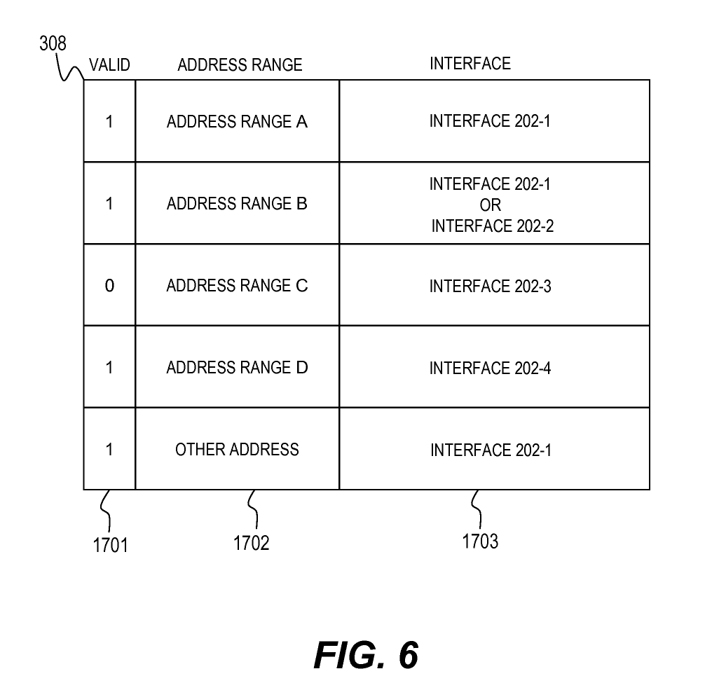

FIG. 6 illustrates an example of a configuration of the distribution information storage unit 308. The distribution information storage unit stores at least one entry including a set of three pieces of information, i.e., address range information 1702 indicating a certain range on a main memory address, interface designation information 1703 indicating any one of the plurality of PCI Express interfaces 202-1, 202-2, 202-3, and 202-4 to which the network interface adaptor 201 is coupled or a plurality of combinations thereof, and a validity flag 1701 indicating validity/invalidity of a set of the address range information 1702 and the interface designation information 1703. In the example of FIG. 6, the distribution information storage unit 308 has information of five entries (five rows). If only entries below five entries are used, 0 (invalid) is set in a validity flag 1701 of an unused entry. A third entry (third row) of the distribution information storage unit 308 illustrated in FIG. 6 is invalid.

The address range information 1702 can contain, for example, a set of a base address and a limit value. In this case, when a certain address A is given, satisfying a relationship of base address <=address A <=(base address+limit value) enables judgment that the address A belongs to the address range.

The address range information 1702 is not always set to cover the entire main memory address space, and hence an interface to be selected as a transmission destination when an address belongs to no address range needs to be defined. In FIG. 6, as in the case of a fifth entry (fifth row) where address range information is other addresses, information indicating an interface, to which a memory transaction of a target address not belonging to any other address range is to be transmitted, can be stored.

Distribution information set by the distribution information storage unit 308 can be set to match characteristics of application software. As a general method for use, however, distribution information is set so that a memory transaction can reach the main memory control unit to which a main memory responsible for its target address is coupled within a short period of time, and congestion of interconnects in the computer 203 can be prevented. A setting example is described by way of a case of the computer 203 illustrated in FIG. 4.

In the computer 203 of FIG. 4, it is presumed that the main memory 402-1 is responsible for an address range A, the main memory 402-2 is responsible for an address range B, the main memory 402-3 is responsible for an address range C, and the main memory 402-4 is responsible for an address range D. A configuration of the network interface adaptor is as illustrated in FIG. 3. In this case, the address ranges A and C are relatively close to the I/O hub 400-1, and the address ranges B and D are relatively close to the I/O hub 400-2. Accordingly, if a memory transaction to the main memory address belonging to the address range A or C is transmitted to the PCI Express interface 202-1 or 202-2, and a memory transaction to the main memory address belonging to the address range B or D is transmitted to the PCI Express interface 202-3 or 202-4, data transfer throughput can be improved. Thus, setting of the distribution information storage unit 308 may be such that a memory transaction to the main memory address belonging to the address range A or C is transmitted to the PCI Express interface 202-1 or 202-2, and a memory transaction to the main memory address belonging to the address range B or D is transmitted to the PCI Express interface 202-3 or 202-4.

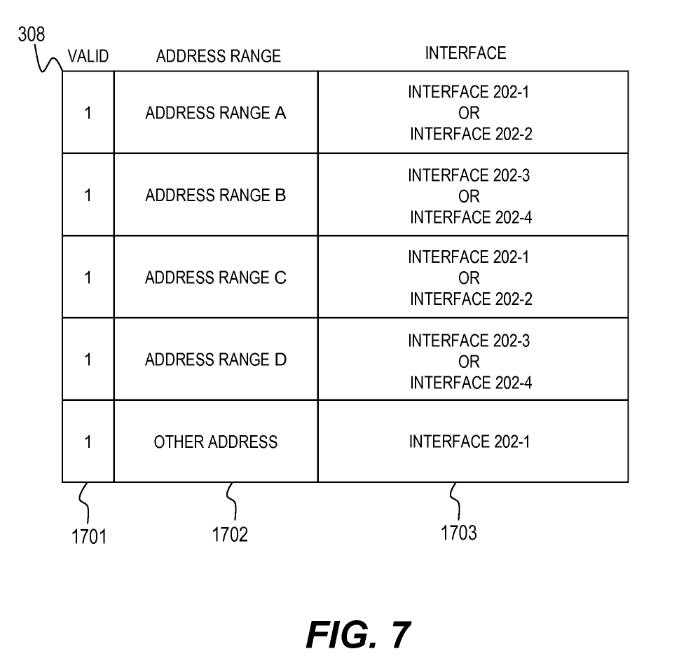

FIG. 7 is an explanatory diagram illustrating a setting example of the distribution information storage unit 308 in the computer 203 of FIG. 4. FIG. 6 illustrates an example in which setting of distribution to the PCI Express interface 202-3 is invalidated when an address belongs to the address range C. Entries of the distribution information storage unit 308 to realize all the paths of FIG. 4 are as illustrated in FIG. 7. FIG. 7 is an explanatory diagram illustrating another example of information set in the distribution information storage unit.

Specifically, in a first entry (first row), 1 (valid) is recorded as a valid bit, an address range A is recorded as address range information, and information indicating the PCI Express interfaces 202-1 and 202-2 is recorded as interface designation information. In a second entry (second row), 1 (valid) is recorded as the valid bit, an address range B is recorded as the address range information, and information indicating the PCI Express interfaces 202-3 and 202-4 is recorded as the interface designation information. In a third entry (third row), 1 (valid) is recorded as the valid bit, an address range C is recorded as the address range information, and information indicating the PCI Express interfaces 202-1 and 202-2 is recorded as the interface designation information. In a fourth entry (fourth row), 1 (valid) is recorded as the valid bit 1, an address range D is recorded as the address range information, and information indicating the PCI Express interfaces 202-3 and 202-4 is recorded as the interface designation information. In a fifth entry (fifth row), 1 (valid) is recorded as the valid bit, information indicating another address is recorded as the address range information, and information indicating the PCI Express interface 202-1 is recorded as the interface designation information.

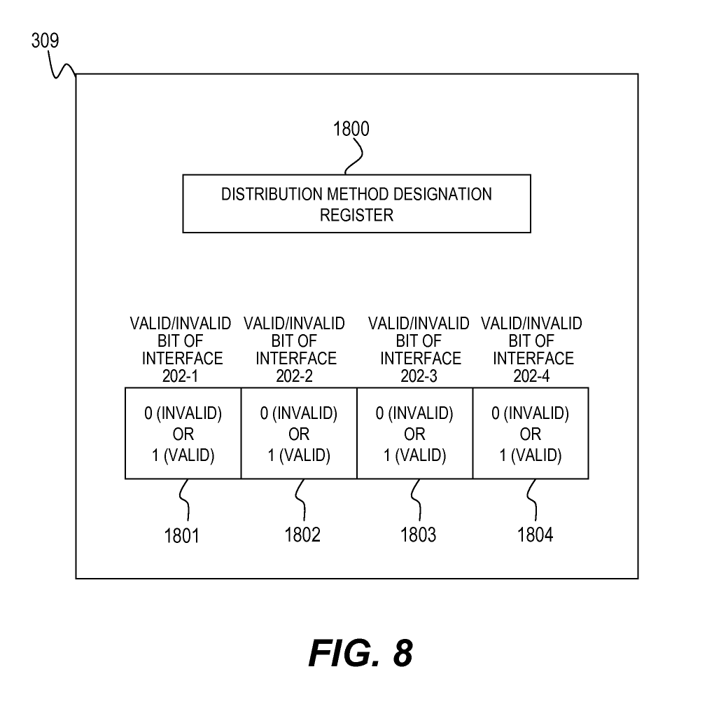

FIG. 8 illustrates an example of a configuration of the distribution method setting unit 309. In the example of FIG. 8, the distribution method setting unit 309 includes a distribution method designation register 1800, and interface valid/invalid bits 1801, 1802, 1803 and 1804. The number of interface valid/invalid bits is equal to the number of PCI Express interfaces (number of PCI Express endpoints of the network interface adaptor 201) for interconnecting the network interface adaptor 201 and the computer 203. In the example of the network interface adaptor 201 illustrated in FIG. 3, the number of interface valid/invalid bits is four so as to match the number of PCI Express interfaces 202-1, 202-2, 202-3, and 202-4.

The distribution method designation register 1800 is used by the memory transaction distribution unit 305 to designate a method for distributing memory transactions to the plurality of PCI Express interfaces 202-1, 202-2, 202-3, and 202-4. When the number of bits of the distribution method designation register 1800 is three, for example, if a stored content of the register is a binary number 000, no distribution is carried out but a memory transaction is transmitted to the PCI Express interface 202-1 in a fixed manner. If a stored content of the register is a binary number 001, a memory transaction is transmitted to the PCI Express interface 202-2 in a fixed manner. If a stored content of the register is a binary number 010, a memory transaction is transmitted to the PCI Express interface 202-3 in a fixed manner. If a stored content of the register is a binary number 011, a memory transaction is transmitted to the PCI Express interface 202-4 in a fixed manner. In the case of a binary number 100, address range information stored in the distribution information storage unit 308 is compared with a target address of a memory transaction to select an interface for transmitting the memory transaction. If a stored content of the register is a binary number 101, an interface is selected by a round-robin method. In other words, the operation of the memory transaction distribution unit 305 can be changed based on a content of a value set in the distribution method designation register 1800.

The interface valid/invalid bits 1801, 1802, 1803, and 1804 designate whether to use the PCI Express interfaces 202-1, 202-2, 202-3, and 202-4 as memory transaction distribution destinations, respectively. For example, during distribution of memory transactions by the round-robin method, if the valid/invalid bit 1801 of the PCI Express interface 202-1 is 1 (valid), the valid/invalid bit 1802 of the PCI Express interface 202-2 is 0 (invalid), the valid/invalid bit 1803 of the PCI Express interface 202-3 is 1 (valid), and the valid/invalid bit 1804 of the PCI Express interface 202-4 is 0 (invalid), in the distribution by the round-robin method, the PCI Express interface 202-2 corresponding to the valid/invalid bit 1802 of the PCI Express interface 202-2 and the PCI Express interface 202-4 corresponding to the valid/invalid bit 1804 of the PCI Express interface 202-4 are not selected. The distribution by the round-robin method is carried out only by the other valid interfaces. In other words, memory transactions are distributed only to the PCI Express interfaces 202-1 and 202-3 by the round-robin method. Not only when the distribution method designation register 1800 designates the round-robin method but also, for example, when distribution is carried out based on information stored in the distribution information storage unit 308, as in the case of the above-mentioned example, an operation can be performed without using any specific interface selected by the interface valid/invalid bit 1801, 1802, 1803 or 1804. Thus, even when a problem such as a failure occurs in any one of the endpoints, the interfaces coupled to the endpoints or the I/O hubs, the operation can be continued in a degenerate manner by removing the interface from targets of the memory transaction distribution.

Setting of each bit and valid/invalid bit in the distribution method designation register 1800 can be performed from software of the computer 203.

FIGS. 9 to 11 illustrate examples of packets to be RDMA-transferred by the network interface adaptor 201. FIG. 9 is an explanatory diagram illustrating an example of the RDMA write request packet for requesting RDMA writing. FIG. 10 is an explanatory diagram illustrating an example of the RDMA read request packet for requesting RDMA reading. FIG. 11 is an explanatory diagram illustrating an example of the RDMA read response packet for returning data requested to be read in response to the RDMA read request.

The RDMA write request packet 1400 of FIG. 9 contains a command 1401, a transmission destination node ID 1402, a transmission source node ID 1403, a flag 1404, a packet sequence number 1405, a write destination address 1406, an authentication key 1407, a data length 1408, data 1409, and a CRC 1410.

The command 1401 indicates a processing content to be requested to a transmission destination from a transmission source through a packet. In the case of the RDMA write request packet 1400, the command 1401 contains information indicating an RDMA write request.

The transmission destination node ID 1402 is information for identifying a transmission destination node of the packet. The transmission source node ID 1403 is information for identifying a transmission source node of the packet.

The flag 1404 contains information indicating attributes of a packet. The attributes of the packet indicated by the flag 1404 include a first packet attribute that indicates a first packet of a series of packets constituting a single RDMA request, a last packet attribute that indicates a last packet of the series of packets constituting the single RDMA request, an only packet attribute that indicates an only packet constituting the single RDMA request, an ACK request attribute that indicates a packet for requesting an ACK for checking packet transmission, and a completion notification request attribute for requesting notification of completion of processing requested through the packet. A plurality of those attributes may be combined for use. For example, in the case of a single RDMA request including a plurality of packets, in order to make a notification of completion of the RDMA request, the flag 1404 of the last packet of the packet group needs to contain a last packet attribute and a completion notification request attribute.

The packet sequence numbers 1405 are sequentially added for respective packets by the packet transmission source. The side that has received the packets inspects the packet sequence numbers 1405 to check sequential arrival. If there is omission of a packet sequence number, an NACK packet is transmitted to the packet transmission source to request retransmission.

The data 1409 is data to be written in the main memory of the transmission destination node, and a virtual address of a write destination is designated by the write destination address 1406. The data length 1408 is a size of the data 1409.

The node that has received the RDMA write request packet, in other words, a node indicated by the transmission destination node ID 1402, inspects whether software on the node indicated by the transmission source node ID 1403 of the transmission source node that has requested transmission of the RDMA write request packet has authority to write data in an area of a main memory indicated by the write destination address 1406 by using the authentication key 1407.

The CRC 1410 is a cyclic redundancy check code for inspecting whether there is any error in a bit string of the RDMA write request packet 1400. If an error is detected, the packet is construed as one that has not reached the reception side, and an NACK packet is transmitted to the packet transmission source to request retransmission.

The RDMA read request packet 1500 of FIG. 10 and the RDMA read response packet 1600 of FIG. 11 are used as a pair for making an RDMA read request and a response thereto

The RDMA read request packet 1500 of FIG. 10 contains a command 1501, a transmission destination node ID 1502, a transmission source node ID 1503, a flag 1504, a packet sequence number 1505, a read destination address 1506, an authentication key 1507, a data length 1508, and a CRC 1509.

The RDMA read response packet 1600 of FIG. 11 contains a command 1601, a transmission destination node ID 1602, a transmission source node ID 1603, a flag 1604, a packet sequence number 1605, a data length 1606, data 1607, and a CRC 1608.

For the RDMA read request packet 1500 and the RDMA read response packet 1600, handling of the flags 1504 and 1604, the packet sequence numbers 1505 and 1605, the CRCs 1509 and 1608, and accompanying completion notification, an ACK packet, and an NACK packet is similar to that of the RDMA write request packet 1400, and hence description thereof is omitted.

A node that has received the RDMA read request packet 1500, in other words, a node indicated by the transmission destination node ID 1502, inspects the authentication key 1507. If reading in the read destination address 1506 can be authenticated, the node reads data of a length indicated by the data length 1508 from the read destination address 1506, and returns data to the RDMA read request source by the RDMA read response packet. The transmission destination node ID 1602 of the RDMA read response packet accordingly becomes the transmission source node ID 1503 of the RDMA read request packet, and the transmission source node ID 1603 of the RDMA read response packet becomes the transmission destination node ID 1502 of the RDMA read request packet. The read data is stored in the data 1607 to be returned to the node of the RDMA read request source.

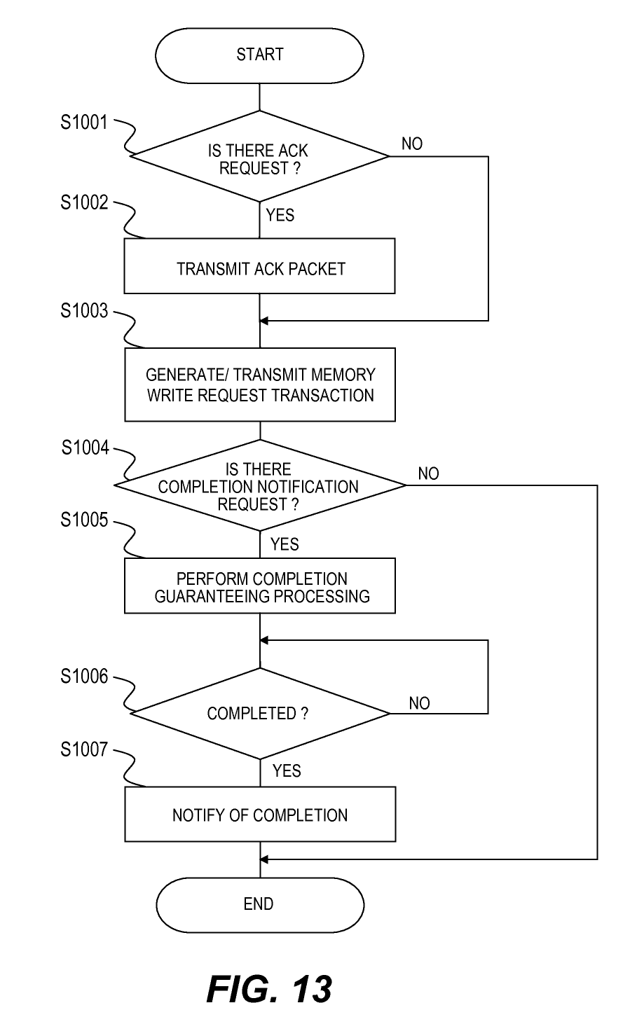

FIGS. 13 to 16 are flowcharts illustrating an operation performed when the network interface adaptor 201 requests another node coupled via the network to perform RDMA transfer, and an operation performed when RDMA transfer is requested by another node. Each flowchart illustrates an overall operation of the network interface adaptor 201, and each step of the flowchart is carried out by one or a plurality of components of the network interface adaptor 201.

FIG. 13 is a flowchart illustrating processing performed when the controller 20 of the network interface adaptor 201 receives the RDMA write request packet 1400 from another node. After the network interface adaptor 201 receives the RDMA write request packet from another node, and completes inspection of the CRC 1410 and the packet sequence number 1405, in Step S1001, the controller 20 first examines whether an ACK for checking packet transmission has been requested.

In order to check arrival of the packet at the transmission destination, the transmission source node of the RDMA write request packet adds a flag for requesting an ACK to the flag 1404 to transmit the RDMA write request packet. If the controller 20 judges that there is an ACK request in the flag 1404 in Step S1001, in Step S1002, an ACK packet is returned to the transmission source of the RDMA write request packet.

In Step S1003, the controller 20 inspects the authentication key 1407 to check whether there is an authority to write data in the write destination address 1406. Then, the controller 20 translates the write destination address 1406 from a virtual address into a physical address to generate a memory write request transaction for writing the data 1409 in the physical address. In this case, because of restrictions on the PCI Express endpoints 310-1, 310-2, 310-3 and 310-4, and the I/O hubs 400-1 and 400-2, the interconnects, or the main memory control units in the computer 203, data contained in a single RDMA write request packet may be divided into a plurality of memory write request transactions. For example, when the RDMA write request packet contains 4-kilobyte data, and a maximum size of data contained in one memory transaction is 256 bytes for the I/O hubs 400-1 and 400-2 of the computer 203, the RDMA write request packet is divided into at least sixteen memory write request transactions. Those memory transactions are distributed to the PCI Express interfaces 202-1, 202-2, 202-3, and 202-4 by the memory transaction distribution unit 305 to be transmitted to the computer 203.

In Step S1004, the controller 20 checks completion of all writing in the main memory of the computer 203 by the memory write request transaction for writing the data contained in the RDMA write request packet transmitted to the computer 203 in the main memory, and judges from the flag 1404 whether there is a completion notification request for notifying the software operated in the computer 203 or the transmission source of the RDMA write request packet of the completion. If the transmission source of the RDMA write request packet has added a flag indicating a completion notification request to the flag 1404, in Steps S1005, S1006, and S1007, the controller 20 performs completion guaranteeing and completion notification.

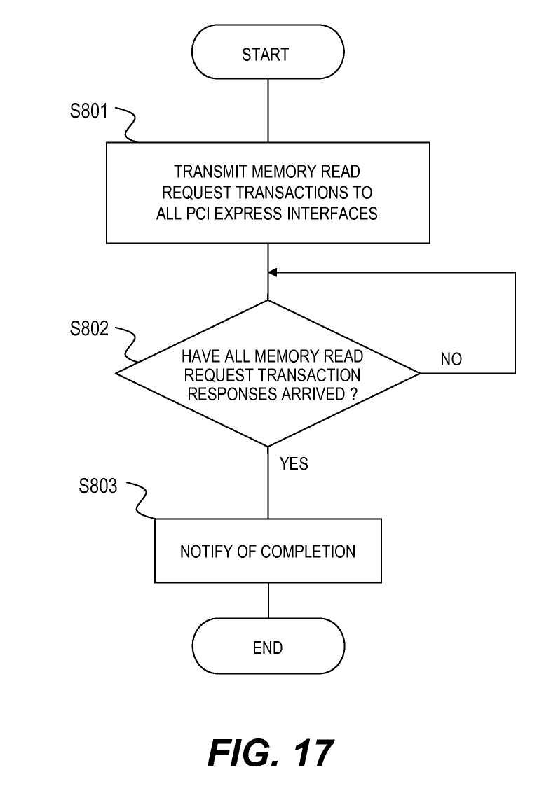

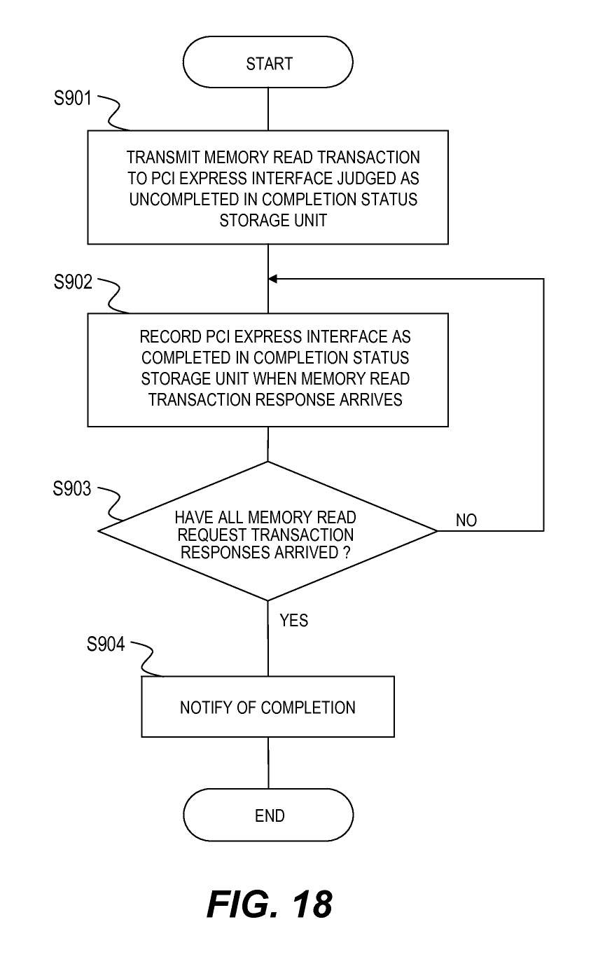

In Step S1005, the controller 20 performs completion guaranteeing processing illustrated in FIG. 17 or FIG. 18. The completion guaranteeing processing illustrated in FIG. 17 or FIG. 18 is described below in detail. In Step S1006, guaranteeing of the completion of writing in the main memory of the computer 203 by the memory write request transaction in Step S1005 is judged. When this completion is guaranteed, in Step S1007, the controller 20 notifies the software operated in the computer 203 or the transmission source of the RDMA write request packet of the completion of data writing by the memory write request transaction.

In Step S1007, in order to notify the software operated in the computer 203 of the completion of data writing by the memory write request transaction, the controller 20 notifies a user application that uses a virtual address space having data written therein by the RDMA write request packet of execution of data writing in an area of the user application by the RDMA write request. In order to notify the transmission source of the RDMA write request packet of the completion of data writing by the memory write request transaction, the controller 20 generates a packet indicating completion of data writing to transmit the packet to the node.

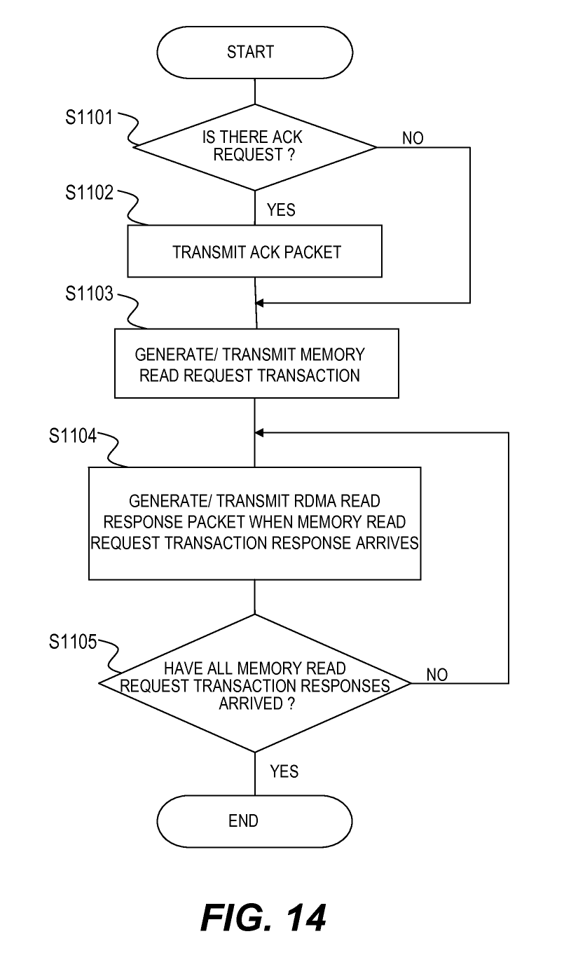

FIG. 14 is a flowchart illustrating processing performed when the controller 20 of the network interface adaptor 201 receives the RDMA read request packet 1500 from another node. After the controller 20 of the network interface adaptor 201 receives the RDMA read request packet 1500 from another node, and completes inspection of the CRC 1509 and the packet sequence number 1505, in Step S1101, the controller 20 first examines whether an ACK for checking packet transmission has been requested.

In order to check arrival of the packet at the transmission destination, the transmission source node of the RDMA read request packet adds a flag for requesting an ACK to the flag 1504 to transmit the RDMA read request packet. If the controller 20 judges that there is an ACK request in Step S1101, in Step S1102, an ACK packet is returned to the transmission source of the RDMA read request packet. In Step S1103, the controller 20 inspects the authentication key 1507 to check whether there is an authority to read data from the read destination address 1506. Then, the controller 20 translates the read destination address 1506 from a virtual address into a physical address to issue a memory read request transaction for requesting reading of data of a length indicated by the data length 1508 from the physical address.

In this case, because of restrictions on the PCI Express endpoints 310-1, 310-2, 310-3 and 310-4, and the interconnects, or the main memory control units in the computer 203, memory reading for data of a data length requested by a single RDMA read request packet may be divided into a plurality of memory read request transactions. Those memory read request transactions are distributed to the PCI Express interfaces 202-1, 202-2, 202-3, and 202-4 by the memory transaction distribution unit 305 to be transmitted to the computer 203.

In Step S1104, after reception of memory read response transactions to the memory read request transactions from the computer 203, the controller 20 generates the RDMA read response packet 1600 based on data contained in the memory read response transactions to transmit the RDMA read response packet 1600 to the transmission source of the RDMA read request packet. In order to check correct arrival of the RDMA read response packet at the transmission destination, the controller 20 adds an ACK request to the flag 1604. This processing is continued until all memory read response transactions to the memory read request transactions are received as indicated in Step S1105. At the time of completion of all the memory read request transactions, processing for the RDMA read request from another node (transmission source) is completed.

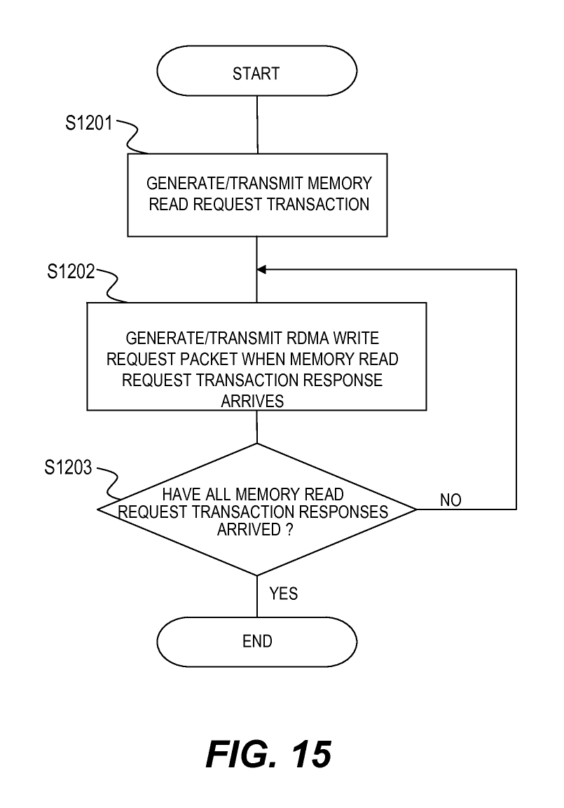

FIG. 15 is a flowchart illustrating processing performed when the controller 20 of the network interface adaptor 201 transmits the RDMA write request packet to another node.

After the software operated in the computer 203 to which the network interface adaptor 201 is coupled has issued an RDMA write request to another node, in Step S1201, the controller 20 generates a memory read request transaction for a main memory address in a local node designated by the RDMA write request, in other words, an address storing data to be transferred to a remote node, to transmit the memory read request transaction to the computer 203. As in the case of the processing performed when the network interface adaptor 201 receives the RDMA read request packet, restrictions on data length to be requested by a single memory read request transaction necessitate division into a plurality of memory read request transactions.

In Step S1202, after reception of memory read response transactions to the memory read request transaction from the computer 203, the controller 20 generates an RDMA write request packet containing the data to transmit the RDMA write request packet to another node. As in Step S1203, this processing is repeatedly executed until all memory read response transactions to the memory read request transaction are received. At the time of completion of all the memory read request transactions, the RDMA write request to another node is completed.

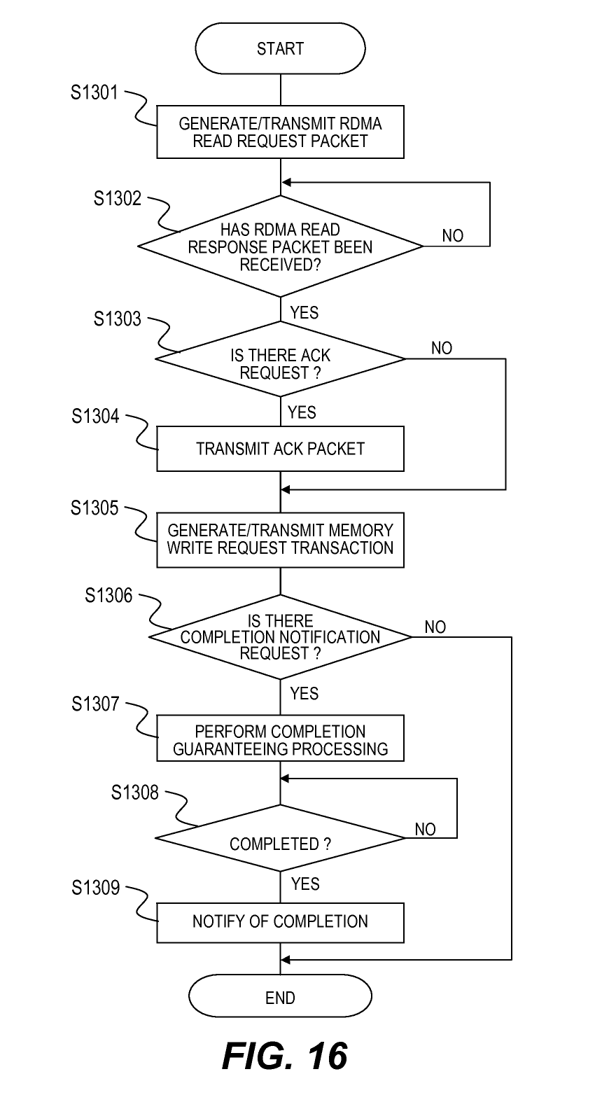

FIG. 16 is a flowchart illustrating processing performed when the controller 20 of the network interface adaptor 201 transmits the RDMA read request packet to another node, and processing performed when the controller 20 receives the RDMA read response packet transmitted from the node.

In response to a request from the software operated in the computer 203 to which the network interface adaptor 201 is coupled, in Step S1301, the controller 20 generates an RDMA read request packet to transmit the RDMA read request packet to another node.

The node that has received the RDMA read request packet returns an RDMA read response packet through the processing illustrated in FIG. 14. Therefore, in Step S1302, the controller 20 waits for returning of the RDMA read response packet. After reception of the RDMA read response packet, the controller 20 inspects the CRC 1608 and the packet sequence number 1605 of the RDMA read response packet 1600. After completion of the inspection, in Step S1303, the controller 20 inspects the flag 1604 of the RDMA read response packet 1600. If there is an ACK request, in Step S1304, the controller 20 returns an ACK packet to the transmission source to notify the transmission source of the reception of the RDMA read response packet.

Then, in Step S1305, the controller 20 issues a memory write request transaction for writing data contained in the received RDMA read response packet in the main memory. In this case, restrictions on the PCI Express endpoints 310-1, 310-2, 310-3 and 310-4, and the interconnects, or the main memory control units in the computer 203 may necessitate division of data contained in a single RDMA read response packet into a plurality of memory write request transactions. The controller 20 accordingly distributes the memory transactions to the PCI Express interfaces 202-1, 202-2, 202-3 and 202-4 by the memory transaction distribution unit 305 to transmit the memory transactions to the computer 203.

In Step S1306, the controller 20 judges from the flag 1604 whether there is a completion notification request for notifying the software operated in the computer 203 or the transmission source node of the RDMA read response packet of completion of writing of data contained in the RDMA read response packet in the main memory. If the transmission source of the RDMA read response packet has added a flag indicating a completion notification request to the flag 1604, in Steps S1307, S1308, and S1309, the controller 20 performs completion guaranteeing and completion notification. In Step S1307, the controller 20 performs the completion guaranteeing processing illustrated in FIG. 17 or FIG. 18. In Step S1308, guaranteeing of the completion of writing in Step S1307 is judged. When this completion of writing is guaranteed, in Step S1309, the controller 20 notifies the software operated in the computer 203 or the transmission source node of the RDMA read response packet of the completion of data writing.

In Step S1309, in order to notify the software operated in the computer 203 of the completion of writing, the controller 20 notifies the software which is operated in the computer 203 and has made the RDMA read request for transmitting the RDMA read request packet corresponding to the RDMA read response packet to the network interface adaptor 201 of completion of data writing in the main memory. In order to notify the transmission source node of the RDMA read response packet of the completion of writing, the controller 20 generates a packet for notifying the node of the completion of writing to transmit the packet to the node.

FIGS. 17 and 18 are flowcharts illustrating completion guaranteeing operations performed by the completion guaranteeing unit 312, for guaranteeing completion in the network interface adaptor 201 by using PCI Express interface protocol. The operations of FIGS. 17 and 18 are described below in detail. It is presumed that during the completion guaranteeing operation of FIG. 17 or 18, in order to prevent disturbed transmission of a memory transaction for completion guaranteeing, the controller 20 performs neither distribution nor transmission of other memory transactions.

FIG. 17 is a flowchart illustrating an example of means for guaranteeing completion of processing of a memory transaction transmitted via the interface in the data transfer unit that performs data transfer with the main memory of the computer via the plurality of PCI Express interfaces. Processing performed by the completion guaranteeing unit 312 of the controller 20 illustrated in FIG. 17 is performed for guaranteeing completion of a preceding memory transaction by uniformly transmitting memory transactions for completion guaranteeing to all the interfaces coupled to the computer 203. In the PCI Express, there is always a memory read response transaction to a memory read request transaction, and hence completion of the memory read request transaction can be known by waiting for this memory read response transaction. On the other hand, for a memory write request transaction, no response transaction is made, and hence a side that has transmitted the memory write request transaction cannot know its completion. Thus, means is realized, which enables a transmission side of a memory write request transaction to know completion of the memory write request transaction by using a order relationship of a memory write request transaction and a memory read request transaction, which is defined by the PCI Express interface protocol.

When completion guaranteeing is requested, in Step S801, the controller 20 transmits memory read request transactions to all the PCI Express interfaces coupled to the network interface adaptor 201, in other words, the PCI Express interfaces 202-1, 202-2, 202-3, and 202-4. In other words, each of totally four memory read request transactions are transmitted to the four PCI Express endpoints 310-1, 310-2, 310-3, and 310-4 of the network interface adaptor 201 coupled to the PCI Express interfaces. In this case, for an address of the main memory read through memory read request transaction, a value preset for completion guaranteeing of a memory write request transaction may be used.

The standard of PCI Express inhibits a memory read request transaction to get ahead of a precedingly transmitted memory write request transaction. Thus, the computer 203 that includes an I/O hub configured based on the PCI Express standard processes the memory read request transaction after processing of all preceding memory write request transactions, and returns a memory read response transaction to the memory read request transaction. In other words, when seen from the network interface adaptor 201, at the time of returning of a memory read response transaction corresponding to the memory read request transaction, a memory write request transaction transmitted ahead of the memory read request transaction has been written in the PCI Express interface that has transmitted the memory read request transaction. Thus, in Step S802, the process waits for responses to all the memory read request transactions transmitted in Step S801.

After reception of the memory read response transactions to all the memory read request transactions, in Step S803, the completion guaranteeing unit 312 transmits a completion notification to the software or the remote node of the computer 203 that has requested the completion guaranteeing to complete the processing.

To guarantee processing completion of all the memory read request transactions transmitted ahead of the memory read request transaction transmitted for completion guaranteeing in Step S801 (memory read request transactions not for completion guaranteeing but for reading data from the main memory, which is necessary for processing an RDMA request), the process only needs to wait for arrival of all responses to the precedingly transmitted memory read request transactions. Through those steps, completion of the preceding memory transactions can be guaranteed.

As described above, however, in this method, a memory read request transaction for completion guaranteeing is transmitted even to the interface having no preceding memory write request transaction, applying needless loads on the interface and the interconnects in the computer.

According to this invention, to reduce a transmission amount of memory read request transactions necessary for completion guaranteeing, the network interface adaptor 201 includes a completion status storage unit 311. FIG. 18 illustrates an operation of the completion guaranteeing unit 312 for performing completion guaranteeing by using the completion status storage unit 311.

FIG. 18 is a flowchart illustrating an example of completion guaranteeing of a memory write request transaction performed by the controller 20 of the network interface adaptor 201. This processing is carried out by the completion guaranteeing unit 312 of FIG. 3.

In Step S901, the completion guaranteeing unit 312 of the controller 20 transmits a memory read request transaction for guaranteeing writing completion of a memory write request transaction to the computer 203. A difference from the completion guaranteeing illustrated in Step S801 of FIG. 17 is that the memory read request transaction for guaranteeing completion is transmitted not to all the interfaces but only to an interface possibly having an uncompleted memory write request transaction in the completion status storage unit 311. The memory transaction distribution unit 305 is in charge of setting as to whether there is any uncompleted one among preceding memory write request transactions issued to the interfaces in the completion status storage unit 311, and its operation is as described above.

The memory transaction distribution unit 305 issues a memory write request transaction to the main memory or the main memory control unit of the computer 203 via any one of the PCI Express interfaces 202-1, 202-2, 202-3, and 202-4. Then, one of the bits 601 to 604 of the completion status storage unit 311, which corresponds to the PCI Express interface that has issued the memory write request transaction, is set to “1”.

The completion guaranteeing unit 312 for guaranteeing memory transaction completion transmits a memory read request transaction for guaranteeing memory transaction completion to the PCI Express interface having one of the bits 601 to 604 of the completion status storage unit 311 set to “1”. In Step S902, after reception of a memory read response transaction to the transmitted memory read request transaction for completion guaranteeing, the controller 20 can guarantee completion of all transmitted preceding memory write request transactions for the interface that has transmitted the memory read request transaction. Thus, in Step S902, the completion guaranteeing unit 312 of the controller 20 stores information indicating completion of all the transmitted preceding memory write request transactions into the completion status storage unit 311 for the interface from which the memory read response transaction to the transmitted memory read request transaction for guaranteeing memory transaction completion has been returned. Specifically, one of the bits 601 to 604 of the completion status storage unit 311, which corresponds to the interface to which the memory read response transaction to the transmitted memory read request transaction for completion guaranteeing has been returned, is set to “0”. In Step S903, the completion guaranteeing unit 312 of the controller 20 waits until reception of all memory read response transactions to the completion guaranteeing memory read request transaction transmitted in Step S901. In other words, the completion guaranteeing unit 312 waits until all the bits 601 to 604 of the completion status storage unit 311 become “0”.

After reception of all the memory read response transactions to the completion guaranteeing memory read request transaction transmitted by the completion guaranteeing unit 312 of the controller 20, in Step S904, the controller 20 notifies the computer 203 or the remote node of the completion, and guarantees completion of the memory transaction (particularly, memory write request transaction) requested by the software of the computer 203 or the remote node.

Through the above-mentioned steps, the completion guaranteeing unit 312 can issue a memory read request transaction for completion guaranteeing only to the PCI Express interface possibly having a transmitted preceding memory write request transaction yet to be completed for writing by referring to the completion status storage unit 311, thereby preventing transmission of a completion guaranteeing memory read request transaction to any interfaces having no preceding memory write request transactions. As a result, completion guaranteeing can be performed with a smaller number of issued memory transactions than that of FIG. 17.

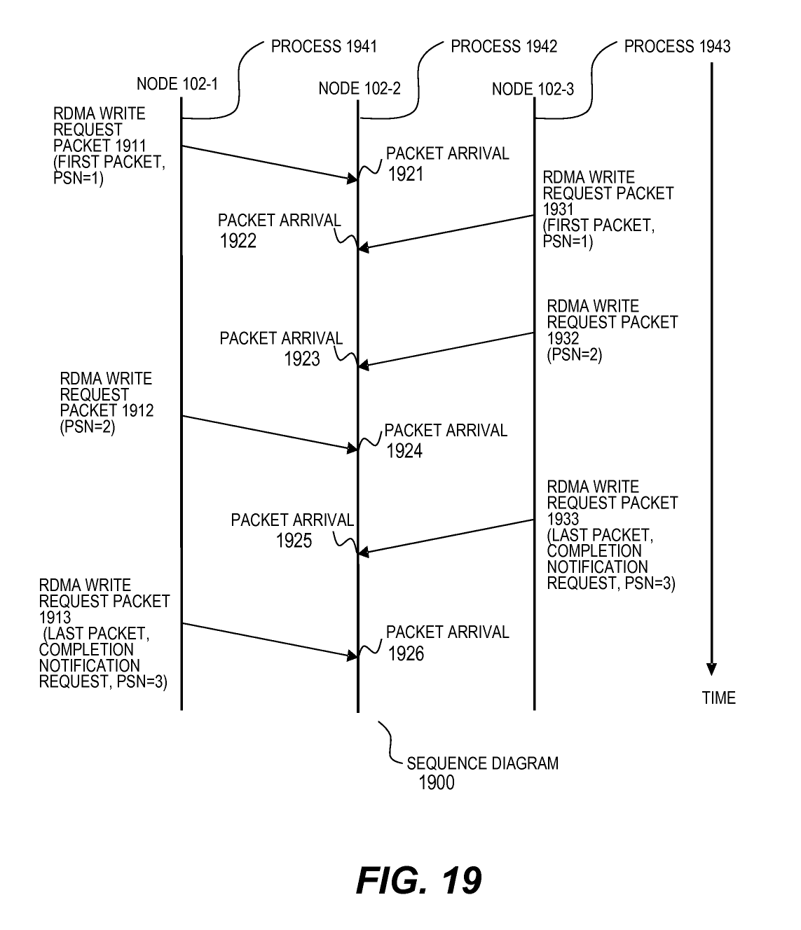

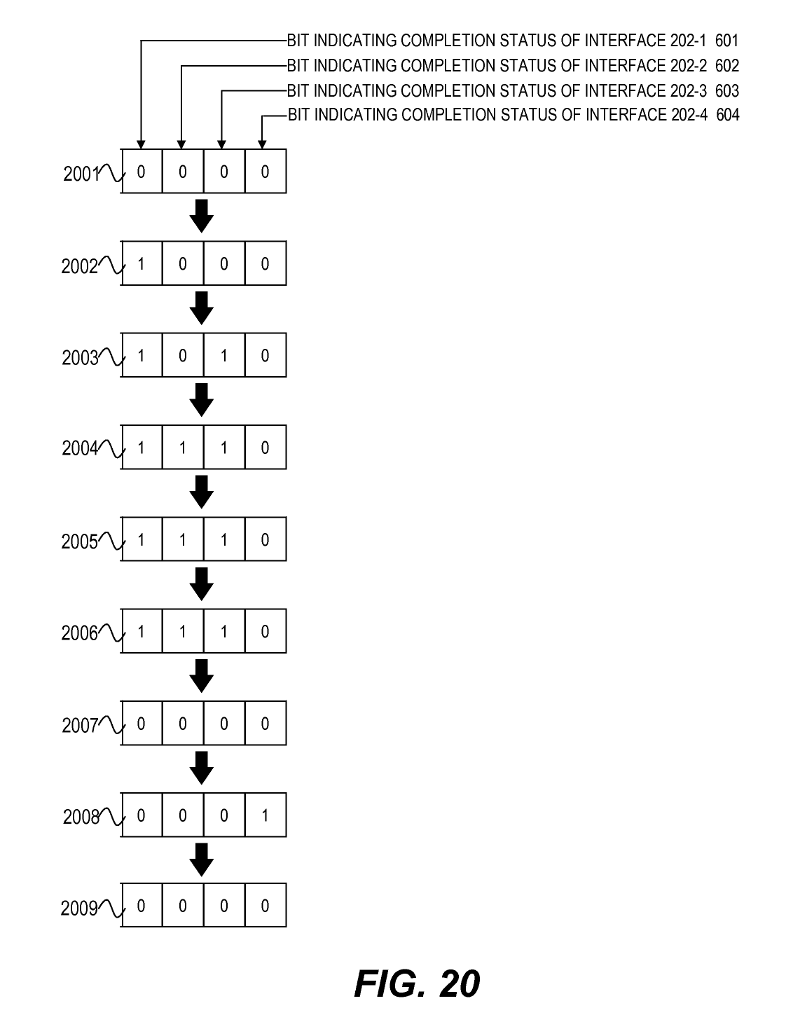

An operation of completion guaranteeing performed by the completion guaranteeing unit 312 by means of the method illustrated in FIG. 18 based on a content to be set in the completion status storage unit 311 by the memory transaction distribution unit 305 and a content of the completion status storage unit 311 in the processing of the RDMA write request packet of FIG. 13 is described referring to a sequence diagram 1900 of FIG. 19 and FIG. 20 illustrating a status of the completion status storage unit 311. FIG. 19 is a sequence diagram illustrating an operation of processing RDMA write request packets from a plurality of nodes in the data transfer unit of the first embodiment of this invention.

The sequence diagram 1900 of FIG. 19 illustrates a temporal order in which the RDMA write request packets arrive at the node 102-2 when the two nodes 102-1 and 102-3 independently transmit the RDMA write request packets to the node 102-2. In FIG. 19, the nodes 102-1 to 102-3 respectively correspond to the nodes 102 illustrated in FIG. 1.

In the sequence diagram, an up-and-down direction indicates time changes, and a left-and-right direction indicates node or process differences. A process 1941 is performed in the node 102-1, and the sequence diagram illustrates a status of time-sequentially transmitting packets 1911, 1912, and 1913 to the node 102-2. Similarly, a process 1943 is performed in the node 102-3, and the sequence diagram illustrates a status of time-sequentially transmitting packets 1931, 1932, and 1933 to the node 102-2. The packets 1911, 1912, and 1913 are a series of packets constituting one RDMA write request from the node 102-1 to the node 102-2. The packets 1931, 1932, and 1933 are a series of packets constituting one RDMA write request from the node 102-3 to the node 102-2. When seen from the node 102-2, the packets transmitted from the node 102-1 and the packets transmitted from the node 102-3 arrive in a mixed manner, which requires the node 102-2 to simultaneously process the two RDMA write requests. The packets 1911, 1912, 1913, 1931, 1932, and 1933 illustrated in FIG. 19 all contain no ACK request.

Referring to FIGS. 18, 13, 19, and 20, an operation of the node 102-2 is described. FIG. 20 is an explanatory diagram illustrating an example of a stored content of the completion status storage unit when RDMA write request packets from a plurality of nodes coupled via the network are processed in the network interface adaptor coupled to the computer via four PCI Express interfaces. The completion status storage unit 311 of the network interface adaptor 201 of the node 102-2 is set in a completion status 2001 as an initial status. First, the RDMA write request packet 1911 arrives at the node 102-2 at the time of a packet arrival 1921. The node 102-2 performs processing performed in the case of reception of the RDMA write request illustrated in FIG. 13. The node 102-2 inspects the packet sequence number 1405 and the CRC 1410 to confirm normalcy. In Step S1001, the node 102-2 checks presence of an ACK request. No ACK request is present, and hence the node 102-2 proceeds to generation and transmission of memory write request transactions of Step S1003. In this case, at least one memory write request transaction for writing data contained in the RDMA write request packet 1911 in a designated address are generated by the memory transaction issuing unit 304.

The generated memory write request transactions are distributed to the interface of any one of the PCI Express interfaces 202-1, 202-2, 202-3, and 202-4 by the memory transaction distribution unit 305. It is presumed that the memory write request transactions generated from the RDMA write request packet 1911 have all been transmitted to the PCI Express interface 202-1 as a result of the distribution. In this case, there may be an uncompleted memory write request transaction in the PCI Express interface 202-1. Thus, as indicated by a completion status 2002 of the completion status storage unit 311, the memory transaction distribution unit 305 sets a bit 601 corresponding to the PCI Express interface 202-1 to 1.

Next, in Step S1004, whether processing for completion notification of Steps S1005 to S1007 has been requested is checked. However, it is presumed that the RDMA write request packet 1911 contains no flag for requesting completion notification. The processing of the RDMA write request packet 1911 is accordingly completed.

Thereafter, RDMA write request packets reaching the node 102-2 are similarly processed. At the time of a packet arrival 1922, the node 102-2 receives an RDMA write request packet 1931 from the node 102-3, and transmits a memory write request transaction to the PCI Express interface 202-3. In this case, a content of the completion status storage unit is as indicated by a completion status 2003. At the time of a packet arrival 1923, the node 102-2 receives an RDMA write request packet 1932 from the node 102-3, and transmits a memory transaction to the PCI Express interface 202-2. In this case, a content of the completion status storage unit 311 is as indicated by a completion status 2004. At the time of a packet arrival 1924, the node 102-2 receives an RDMA write request packet 1912, and transmits a memory write request transaction to the PCI Express interface 202-2. In this case, a content of the completion status storage unit is as indicated by a completion status 2005. The completion statuses are identical between the completion status 2004 and the completion status 2005. However, the memory transaction distribution unit 305 responsible for rewriting the completion status storage unit 311 operates a bit of the interface of the completion status storage unit 311 for each distribution of memory transactions.

At the time of a packet arrival 1925, an RDMA write request packet 1933 is received, and a memory transaction is transmitted to the PCI Express interface 202-2. In this case, a content of the completion status storage unit 311 is as indicated by a completion status 2006 of FIG. 20. A last packet attribute and a completion notification request attribute are added as flags to the RDMA write request packet 1933. Processing for completion notification, in other words, Steps S1005, S1006, and S1007 of FIG. 13 are executed. Completion guaranteeing processing of Step S1005 specifically correspond to Steps S901, S902, S903, and S904 of FIG. 18. In Step S901, memory read request transactions are transmitted to interfaces judged as uncompleted in the completion status storage unit (interfaces corresponding to one of the bits 601 to 604 of the completion status storage unit 311, which has a value “1”), in other words, the PCI Express interfaces 202-1, 202-2, and 202-3 judged as uncompleted in the completion status 2006, to complete preceding memory write request transactions. In Step S902, for interfaces to which memory read response transactions to the memory read request transactions have been returned, the completion guaranteeing unit 312 judges that all the preceding memory write request transactions have been completed to write information indicating completion of the memory write request transactions of the interfaces in the completion status storage unit 311.

In the example of FIG. 20, bits corresponding to the interfaces are “0”. This processing is repeated until all responses to the memory read request transactions are obtained as illustrated in Step S903, and hence the PCI Express interfaces 202-1, 202-2, and 202-3 that have transmitted the memory read request transactions are all guaranteed for completion of transmitted preceding write request transactions, and bits corresponding to the interfaces of the completion status storage unit 311 become “0”. Thus, a content of the completion status storage unit 311 is as indicated by a completion status 2007.

Completion of all the preceding memory write request transactions transmitted to the PCI Express interface 202-1 means that memory transactions based on the RDMA write request packet 1911 have all been completed. Completion of all the preceding memory write request transactions transmitted to the PCI Express interface 202-2 means that memory write request transactions based on the RDMA write request packets 1912, 1932, and 1933 have all been completed. Completion of all the preceding memory write request transactions transmitted to the PCI Express interface 202-3 means that memory write request transactions based on the RDMA write request packet 1931 have all been completed. With a completion notification request made by the RDMA write request packet 1933, the memory write request transactions based on the RDMA write request packets 1911, 1912, 1931, 1932, and 1933 have all been completed. The three RDMA write request packets 1931, 1932, and 1933 constituting one RDMA write request from the node 102-3 have all been completed as described above. Completion of the RDMA write request from the node 102-3 is guaranteed, enabling notification of the completion.

At the time of a packet arrival 1926, the RDMA write request packet 1913 is received, and a memory transaction is transmitted to the PCI Express interface 202-4. In this case, a content of the completion status storage unit 311 is as indicated by a completion status 2008. A last packet attribute and a completion notification request attribute are added as flags to the RDMA write request packet 1913. Thus, as in the case of the packet arrival 1925, processing for completion notification is executed. As indicated by the completion status 2008, preceding memory write request transactions transmitted to the PCI Express interface 202-4 may remain uncompleted in the completion status storage unit 311. A memory read request transaction is transmitted to the PCI Express interface 202-4. After reception of a memory read response transaction, a bit corresponding to the PCI Express interface 202-4 is set to “0”. The completion status storage unit 311 is set as indicated by a completion status 2009. By this completion guaranteeing, completion of a preceding memory write request transaction transmitted to the PCI Express interface 202-4, in other words, a memory write request transaction based on the RDMA write request packet 1913, is guaranteed. Packets constituting one RDMA write request from the node 102-1 include RDMA write request packets 1911 and 1912 in addition to the RDMA write request packet 1913. However, those two packets have been guaranteed for completion by the completion guaranteeing processing performed at the time of the packet arrival 1925. At the time of the packet arrival 1926, the completion of the RDMA write request packet 1913 is guaranteed. As a result, completion of all the three packets 1911, 1912, and 1913 constituting one RDMA write request from the node 102-1 is guaranteed, enabling completion notification of the RDMA write request.

If there is provided no completion status storage unit 311 of this invention or completion guaranteeing unit 312 operated based on a content of the completion status storage unit 311, in other words, when the processing of FIG. 17 is performed, in the above-mentioned example, at the stages of the packet arrival 1925 and the packet arrival 1926, memory read request transactions for completion guaranteeing need to be transmitted to all the PCI Express interfaces 202-1, 202-2, 202-3, and 202-4, and the process needs to wait for all memory read response transactions. In this case, memory read request transactions are transmitted eight times in total. On the other hand, in the example where the completion status storage unit 311 is introduced, memory read request transactions are transmitted four times in total. Thus, an influence of transmission of an additional transaction (memory read request transaction) for completion guaranteeing on the interface and the I/O hub of the computer can be reduced.

As described above, according to the data transfer unit (network interface adaptor 201) of this embodiment, the presence of the distribution information storage unit 308, the distribution method setting unit 309, and the completion status storage unit 311 enables improvement of data transfer performance from the data transfer unit to the main memory. Selection of an interface for transmitting a memory transaction by the memory transaction distribution unit 305 based on the distribution information storage unit 308 storing distribution information obtained by considering the internal configuration of the computer 203 enables improvement of data transfer performance from the data transfer unit to the main memory of the computer. Transmission of an additional memory transaction necessary for completion guaranteeing only to an interface possibly having an uncompleted memory transaction based on the completion status storage unit 311 updated by the memory transaction distribution unit 305 and the completion guaranteeing unit 312 enables reduction of overheads accompanying completion guaranteeing, and suppression of adverse influence on data transfer performance from the data transfer unit to the main memory of the computer. The distribution method setting unit 309 for enabling the software operated on the computer coupled to the data transfer unit to judge validity/invalidity of a distribution method of the memory transaction distribution unit 305 or an interface used as a distribution destination enables selection of an appropriate distribution method according to characteristics of the software or a purpose such as debugging. When abnormalities occur in some of the plurality of interfaces, the abnormal interfaces are cut off to realize a degenerate operation.

As described above, this invention enables improvement of data transfer performance from the data transfer unit coupled to the computer via the plurality of interfaces to the main memory of the computer.

Even in the case of the computer illustrated in FIG. 4 where each processor constituting the computer includes a main memory control unit, and uses not a point-to-point type interconnect such as HyperTransport or Intel's QuickPath Interconnect but a shared type bus between the processors or between the processor and the I/O hub, the data transfer unit of this invention can be coupled to be used.

<Case in which this Invention is not Applied>

Next, a case in which this invention is not applied is described. FIG. 21 is a block diagram illustrating another configuration of a computer to which the data transfer unit of the first embodiment of this invention is coupled.

For simpler description, a computer 203A of FIG. 21 is configured by using two processors for the computer 203 of FIG. 4. The computer 203A includes I/O hubs 500-1 and 500-2 to couple a network interface adaptor 201 via a plurality of interfaces, which are respectively coupled to processor 501-1 and 501-2 via interconnects 504-1 and 504-2. The I/O hubs 500-1 and 500-2 provide a plurality of interfaces 202-1, 202-2, 202-3, and 202-4 to couple a data transfer unit. As in the case of the computer 203 of FIG. 4, the interfaces 202-1, 202-2, 202-3, and 202-4 are interfaces such as PCI Express. Those interfaces 202-1, 202-2, 202-3, and 202-4 are coupled to the network interface adaptor 201.

The processors 501-1 and 502-2 each include a main memory control unit, and are coupled to main memories via memory buses 503-1 and 503-2, respectively.

In FIG. 21, the processor 501-1 is coupled to a main memory 502-1 via the memory bus 503-1, and the processor 501-2 is coupled to a main memory 502-2 via the memory bus 503-2. The processors 501-1 and 501-2 are coupled to each other by an interconnect 505. Interconnects 504-1, 504-2, and 505 are interconnects such as HyperTransport or QuickPath Interconnect described above. The computer 203A has a single main memory space, and the main memories 502-1 and 502-2 are responsible for parts of the space.

Processing of memory transactions from the network interface adaptor 201 in the computer 203A of FIG. 21 is classified into the following four kinds.

(1) When a memory transaction is transmitted to an address belonging to the main memory 502-1 via the interface 202-1 or 202-2 from the network interface adaptor 201, the memory transaction reaches the main memory control unit of the processor 501-1 via the interface 202-1 or 202-2, the I/O hub 500-1, the interconnect 504-1, and the processor 501-1. The main memory control unit reads/writes data in the main memory 502-1 via the memory bus 503-1. In the case of reading in the main memory 502-1, a memory transaction for transferring a result of the reading to the network interface adaptor 201 is transmitted in a reverse order of the same path, in other words, via the processor 501-1, the interconnect 504-1, the I/O hub 500-1, and the interface 202-1 or 202-2.

(2) When a memory transaction is transmitted to an address belonging to the main memory 502-2 via the interface 202-3 or 202-4 from the network interface adaptor 201, the memory transaction reaches the main memory control unit of the processor 501-2 via the interface 202-3 or 202-4, the I/O hub 500-2, the interconnect 504-2, and the processor 501-2. The main memory control unit reads/writes data in the main memory 502-2 via the memory bus 503-2. In the case of reading in the main memory 502-2, a memory transaction for transferring a result of the reading to the network interface adaptor 201 is transmitted in a reverse order of the same path, in other words, via the processor 501-2, the interconnect 504-2, the I/O hub 500-2, and the interface 202-3 or 202-4.

(3) When a memory transaction is transmitted to an address belonging to the main memory 502-2 via the interface 202-1 or 202-2 from the network interface adaptor 201, the memory transaction reaches the main memory control unit of the processor 501-2 via the interface 202-1 or 202-2, the I/O hub 500-1, the interconnect 504-1, the processor 501-1, the interconnect 505, and the processor 501-2. The main memory control unit reads/writes data in the main memory 502-2 via the memory bus 503-2. In the case of reading in the main memory 502-2, a memory transaction for transferring a result of the reading to the network interface adaptor 201 is transmitted in a reverse order of the same path, in other words, via the processor 501-2, the interconnect 505, the processor 501-1, the interconnect 504-1, the I/O hub 500-1, and the interface 202-1 or 202-2.

(4) When a memory transaction is transmitted to an address belonging to the main memory 502-1 via the interface 202-3 or 202-4 from the network interface adaptor 201, the memory transaction reaches the main memory control unit of the processor 501-1 via the interface 202-3 or 202-4, the I/O hub 500-2, the interconnect 504-2, the processor 501-2, the interconnect 505, and the processor 501-1. The main memory control unit reads/writes data in the main memory 502-1 via the memory bus 503-1. In the case of reading in the main memory 502-1, a memory transaction for transferring a result of the reading to the network interface adaptor 201 is transmitted in a reverse order of the same path, in other words, via the processor 501-1, the interconnect 505, the processor 501-2, the interconnect 504-2, the I/O hub 500-2, and the interface 202-3 or 202-4.

The network interface adaptor 201 transmits the memory transaction to the address belonging to the main memory 502-1 or 502-2 to any one of the interfaces 202-1, 202-2, 202-3, and 202-4 by round-robin, weighted round-robin, or address interleaving. In this case, processing of the memory transaction in the computer 203A may be any of the above (1) to (4). As a result, the following problems occur.

As compared with (1) and (2), latency is delayed due to passage via the interconnect 505 in (3) and (4). When (3) and (4) are simultaneously performed, the interconnect 505 becomes a bottleneck unless the interconnect 505 has sufficiently high throughput with respect to the interconnects 504-1 and 504-2 and the interfaces 202-1, 202-2, 202-3, and 202-4. As a result, while dispersion of memory transactions to a plurality of interfaces enables improvement of throughput from the network interface adaptor 201 to the I/O hubs 500-1 and 500-2 of the computer 203A, data transfer performance from the network interface adaptor 201 to the main memories 502-1 and 502-2 cannot be improved. For example, as described above, when the interconnects 504-1 and 504-2 and the interconnect 505 are equal in throughput, if (3) and (4) are simultaneously performed, contention may occur at the interconnect 505. Thus, in the interfaces 202-1, 202-2, 202-3, and 202-4, it seems that high throughput is obtained by transmitting the memory transactions in a dispersed manner. However, data transfer performance to the main memory drops below throughput of the interconnect means.

To guarantee processing of memory transactions transmitted to the main memory or the main memory control unit of the computer from the network interface adaptor 201 via the interface, in other words, to guarantee completion of reading/writing of data in the main memory, completion of all memory transactions respectively transmitted to the interface 202-1, the interface 202-2, the interface 202-3, and the interface 202-4 needs to be guaranteed. As a completion guaranteeing method, for example, in the case of the PCI Express, the following method may be used.

In the case of the PCI Express, the standard inhibits processing of a memory read request transaction before completion of processing of a preceding memory write request transaction. Thus, a memory read request transaction is issued, and completion of a preceding memory write request transaction can be guaranteed at the time of returning of a response to the memory read request transaction. The memory read request transaction is always accompanied by a response for returning a reading result to a memory transaction request source. Hence, to guarantee completion of the memory read request transaction, the process only needs to wait for this response.

The network interface adaptor 201 is coupled to the computer 203A via the plurality of interfaces, and hence a transaction for completion guaranteeing needs to be transmitted to each interface. However, when transactions for completion guaranteeing are transmitted to all the interfaces, the memory read request transactions for completion guaranteeing are transmitted even to interfaces to which no memory write request transaction has been transmitted for one reason or another, which results in imposing extra loads on the interface and the I/O hub of the computer coupled via the interface.

<Case in which this Invention is Applied>

In a case in which this invention is applied to the computer 203A of FIG. 21, as in the case of the computer 203 of FIG. 4, data transfer throughput can be improved by distributing memory transactions in parallel to the plurality of main memories 502-1 and 502-2 of the computer 203A with the use of a plurality of interfaces while preventing resource contention of the computer 203A.

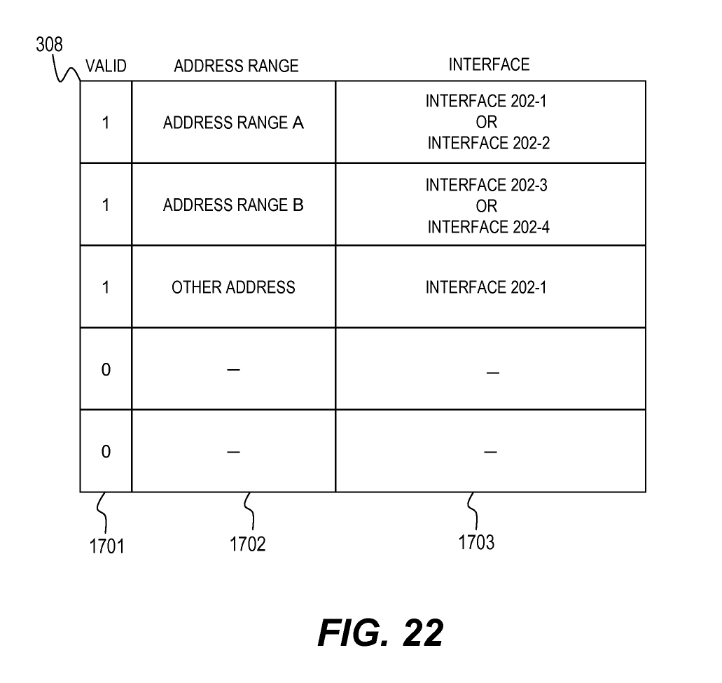

FIG. 22 is an explanatory diagram illustrating an example of setting of the distribution information storage unit 308 in the case where this invention is applied to the computer 203A of FIG. 21.

In the distribution information storage unit 308 illustrated in FIG. 22, in a first entry (first row), 1 (valid) is recorded as the valid bit, an address range A is recorded as address range information, and information indicating the PCI Express interfaces 202-1 and 202-2 is recorded as interface designation information. In a second entry (second row), 1 (valid) is recorded as the valid bit, an address range B is recorded as the address range information, and information indicating the PCI Express interfaces 202-3 and 202-4 is recorded as the interface designation information. An address belonging to none of the address range A and the address range B is transmitted via the PCI Express interface 202-1. As information necessary therefor, a valid bit of a third entry (third row) is set to 1 (valid), information indicating another address is recorded in the address range information, and information indicating the PCI Express interface 202-1 is recorded in the interface designated information. For a fourth entry (fourth row) and subsequent entries, valid bits are set to 0 (invalid) since they are not used.

The above-mentioned setting prevents collision of the memory transactions at the interconnect 505 coupling the processors 501-1 and 501-2, enabling fast data transfer at the plurality of interfaces 202-1 to 202-4.

Thus, this invention enables improvement of data transfer performance from the data transfer unit coupled to the computer via the plurality of interfaces to the main memory of the computer.

### Second Embodiment

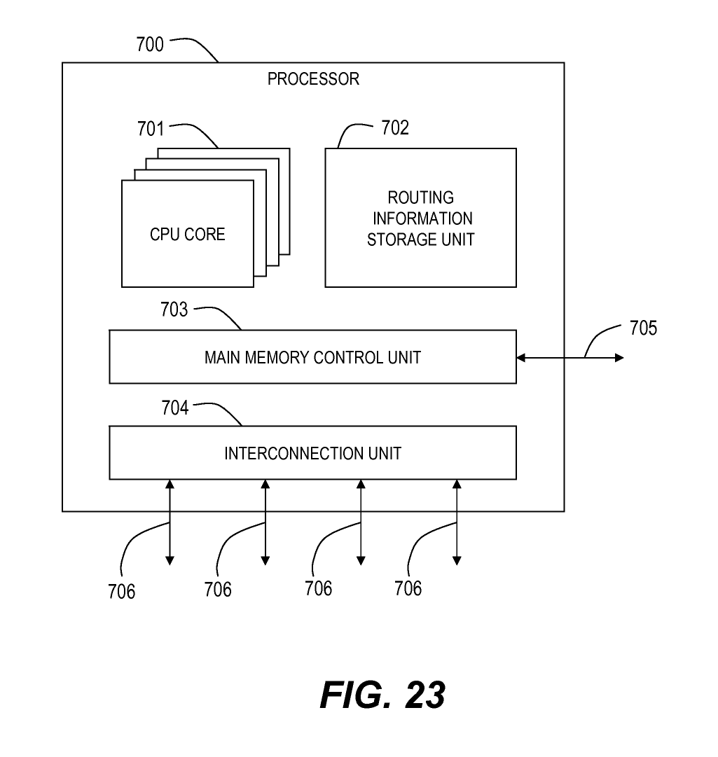

FIG. 23 is a block diagram illustrating an example of a configuration of a processor in a computer to which the data transfer unit of the first embodiment of this invention is coupled.

FIG. 23 is a block diagram illustrating another configuration of the processor, that is, a processor 700 used in the computer 203 illustrated in FIGS. 4 and 21.

The processor 700 includes at least one CPU core 701, a routing information storage unit 702, a main memory control unit 703, and an interconnection unit 704.

The main memory control unit 703 is coupled to the main memory via at least one memory bus 705.

The interconnection unit 704 provides at least one interconnect 706 for interconnection between processors or between a processor and an I/O hub, and is coupled to another processor or an I/O hub. Specifically, the interconnects 706 correspond to the interconnects 404-1, 404-2, 404-3, 404-4, 405-1, 405-2, 405-3, 405-4, 405-5, and 405-6 illustrated in FIG. 4, and the interconnects 504-1, 504-2, and 505 illustrated in FIG. 21.

The routing information storage unit 702 stores a pair of information indicating a range in a main memory address and information indicating a processor including a main memory control unit coupled to the main memory to which a physical address of the range belongs. The routing information storage unit 702 stores a pair of information indicating a processor and information indicating one of the plurality of interconnects 706, which is to be selected when a memory transaction is transmitted to the processor.

By combining the two types of information stored in the routing information storage unit 702, even in the configuration illustrated in FIG. 4 or FIG. 21 where the main memories constituting the single physical address space are coupled in a dispersed manner to the main memory control units of the plurality of processors, the processor 700 can transfer the memory transaction to a processor including the main memory control unit 703 which needs to process a memory transaction of its target address. Its processing procedure is described below.

When software operated on the processor executes a command that requires memory access, if a target physical address of the memory access belongs to the main memory coupled to the main memory control unit 703 of the processor, memory access is requested to the main memory control unit 703. If the target physical address of the memory access does not belong to the main memory coupled to the main memory control unit 703 of the processor, information indicating the processor having the main memory control unit 703 to which the main memory of the address is coupled is obtained from the routing information storage unit 702. Next, information indicating an interconnect corresponding to the processor is obtained from the routing information storage unit 702. The main memory control unit 703 transmits a memory transaction for requesting the memory access to the interconnect. The memory transaction reaches another processor via the interconnect 706. If the target address of the memory transaction belongs to the main memory coupled to the main memory control unit 703 of the reached processor, this processor processes the memory transaction.

On the other hand, if the target address of the memory transaction does not belong to the main memory of the main memory control unit 703 of the reached processor, this processor transfers the memory transaction to another processor by referring to the routing information storage unit 702 again. If the routing information storage unit 702 of each processor is correctly set, the above operation is repeated, and the memory transaction eventually reaches a processor that can process the target address. A memory transaction transmitted from a device coupled to the outside to the processor is processed in a similar manner.

Specific description has been made of the embodiments of this invention. Needless to say, however, those embodiments are in no way limitative of this invention, and various modifications and changes can be made without departing from the spirit and scope of the invention.

Each of the embodiments has disclosed the network interface adaptor 201 as the data transfer unit. However, an arbitrary data transfer unit for accessing a main memory can be configured by changing the network interface 301 of FIG. 3. For example, a host bus adaptor can be configured by setting the interface 301 coupled to the external device as a fiber channel interface.

The data transfer unit of this invention can be applied to a data transfer unit coupled to a computer via a plurality of interfaces to perform data transfer with a main memory or a main memory control unit of the computer.

While the present invention has been described in detail and pictorially in the accompanying drawings, the present invention is not limited to such detail but covers various obvious modifications and equivalent arrangements, which fall within the purview of the appended claims.

What is claimed is:

1. A data transfer unit, comprising:
a first interface coupled to a computer;
a second interface coupled to an external device; and
a control unit for transferring data between the first interface and the second interface,
the control unit comprising at least one memory transaction issuing unit for issuing, when one of the first interface and the second interface receives an access request to a main memory of the computer, a memory transaction for the main memory to the first interface, wherein:
the first interface comprises a plurality of interfaces coupled in parallel to the computer; and
the control unit is configured to:
extract an address of the main memory, which is contained in the memory transaction issued by the at least one memory transaction issuing unit; and
transmit the memory transaction to one of the plurality of interfaces according to the extracted address.

2. The data transfer unit according to claim 1, wherein the control unit further comprises a memory transaction distribution unit for selecting, based on correspondence between a preset transfer destination address of the memory transaction and the plurality of interfaces, an interface having address designation information set therein, which corresponds to the extracted address from the plurality of interfaces, and transmitting the memory transaction to the selected interface.

3. The data transfer unit according to claim 2, wherein:
the control unit further comprises a distribution information storage unit for storing the address designation information describing the correspondence; and
the memory transaction distribution unit selects, by referring to the distribution information storage unit based on the address of the main memory, which has been extracted from the memory transaction, the interface having the address designation information set therein, which corresponds to the address.

4. The data transfer unit according to claim 2, wherein the control unit further comprises a completion guaranteeing unit for notifying, if the received access request contains a completion guaranteeing request of the memory transaction, when completion of access to the main memory for the memory transaction transmitted by the memory transaction distribution unit is detected, one of the computer and a transmission source of the access request of the completion of the memory transaction.

5. The data transfer unit according to claim 4, wherein:
the control unit further comprises a completion status storage unit for storing information for identifying one of the completion and noncompletion of the memory transaction for each of the plurality of interfaces to which the memory transaction distribution unit has transmitted the memory transaction; and
the completion guaranteeing unit is configured to:
issue, if the received access request contains the completion guaranteeing request of the memory transaction, a completion guaranteeing transaction to the one of the plurality of interfaces for which the information of the completion status storage unit indicates the noncompletion; and
detect, when all responses to the completion guaranteeing transaction are received, the completion of the access to the main memory for the memory transaction.

6. The data transfer unit according to claim 2, wherein:
the control unit further comprises a distribution method setting unit for setting a condition for selecting, by the memory transaction distribution unit, the one of the plurality of interfaces; and
the memory transaction distribution unit selects the one of the plurality of interfaces under the condition set by the distribution method setting unit.

7. The data transfer unit according to claim 6, wherein the distribution method setting unit comprises a storage unit for setting one of validity and invalidity of data transfer for the each of the plurality of interfaces.

8. The data transfer unit according to claim 1, wherein the second interface is a network interface, which is coupled to a network, for transmitting and receiving a signal.

9. The data transfer unit according to claim 8, wherein the second interface performs DMA transfer between a computer coupled to the network and the main memory of the computer coupled to the first interface.

10. The data transfer unit according to claim 1, wherein the first interface is configured by PCI Express.

11. The data transfer unit according to claim 5, wherein, for the completion guaranteeing transaction, a memory read request transaction is used.
